(19) United States
(12) Patent Application Publication
(10) Pub. No.: US 2023/0012272 A1
(43) Pub. Date: Jan. 12, 2023

(54) WEARABLE SYSTEMS AND METHODS FOR SELECTIVELY READING TEXT

(71) Applicant: ORCAM TECHNOLOGIES LTD., Jerusalem (IL)

(72) Inventors: Yonatan Wexler, Jerusalem (IL); Amnon Shashua, Mevaseret Zion (IL); Tal Rosenwein, Jerusalem (IL)

(21) Appl. No.: 17/756,991

(22) PCT Filed: Dec. 10, 2020
(86) PCT No.: PCT/IB2020/001029

§ 371 Date: Jun. 7, 2022

Related U.S. Application Data
(60) Provisional application No. 62/947,024, filed on Dec. 12, 2019.

(51) Int. Cl. G10L 13/02; G06V 30/148; G06V 40/20; G06F 3/01

(52) U.S. Cl. CPC G10L 13/02; G06V 30/153; G06V 40/20; G06F 3/017

(57) ABSTRACT

Systems and methods are disclosed for selectively reading text. A system may comprise an image capture device, an audio capture device, and a processor. The processor may be configured to receive images captured by the image capture device and audio signals captured by the audio capture device. The processor may analyze the image to identify text represented in the image; identify, based on the image, a structural element of the text; identify a request to read a first portion of the text associated with the structural element, the request being identified by at least one of analyzing the audio signals to detect a spoken request or detecting a gesture in the plurality of images; and present the first portion of text to the user of the wearable device.

### CROSS REFERENCE TO RELATED APPLICATION

This application claims the benefit of priority of U.S. Provisional Patent Application No. 62/947,024, filed on Dec. 12, 2019, which is incorporated herein by reference in its entirety.

### BACKGROUND

### Technical Field

This disclosure generally relates to devices and methods for capturing and processing images and audio from an environment of a user, and using information derived from captured images and audio.

### Background Information

Today, technological advancements make it possible for wearable devices to automatically capture images and audio, and store information that is associated with the captured images and audio. Certain devices have been used to digitally record aspects and personal experiences of one's life in an exercise typically called “lifelogging.” Some individuals log their life so they can retrieve moments from past activities, for example, social events, trips, etc. Lifelogging may also have significant benefits in other fields (e.g., business, fitness and healthcare, and social research). Lifelogging devices, while useful for tracking daily activities, may be improved with capability to enhance one's interaction in his environment with feedback and other advanced functionality based on the analysis of captured image and audio data.

Even though users can capture images and audio with their smartphones and some smartphone applications can process the captured information, smartphones may not be the best platform for serving as lifelogging apparatuses in view of their size and design. Lifelogging apparatuses should be small and light, so they can be easily worn. Moreover, with improvements in image capture devices, including wearable apparatuses, additional functionality may be provided to assist users in navigating in and around an environment, identifying persons and objects they encounter, and providing feedback to the users about their surroundings and activities. Therefore, there is a need for apparatuses and methods for automatically capturing and processing images and audio to provide useful information to users of the apparatuses, and for systems and methods to process and leverage information gathered by the apparatuses.

### SUMMARY

Embodiments consistent with the present disclosure provide devices and methods for automatically capturing and processing images and audio from an environment of a user, and systems and methods for processing information related to images and audio captured from the environment of the user.

In an exemplary embodiment, a wearable apparatus may comprise at least one image capture device configured to capture a plurality of images from an environment of the user of the wearable apparatus; at least one audio capture device configured to receive sounds from the environment of the user; and at least one processor. The at least one processor may be configured to receive an image captured by the image sensor; receive audio signals representative of the sounds captured by the audio capture device; analyze the image to identify text represented in the image; identify, based on the image, a structural element of the text; identify a request to read a first portion of the text associated with the structural element, the request being identified by at least one of analyzing the audio signals to detect a spoken request or detecting a gesture in the plurality of images; and present the first portion of text to the user of the wearable device.

In another exemplary embodiment, a method selectively reading text is disclosed. The method may comprise receiving a plurality of images captured by an image capture device from an environment of the user; receiving audio signals representative of sounds captured by an audio capture device from the environment of the user; analyzing at least one image of the plurality of images to identify text represented in the image; identifying, based on the image, a structural element of the text; identifying a request to read a first portion of the text associated with the structural element, the request being identified by at least one of analyzing the audio signals to detect a spoken request or detecting a gesture in the plurality of images; and presenting the first portion of text to the user of the wearable device.

Consistent with other disclosed embodiments, non-transitory computer readable storage media may store program instructions, which are executed by at least one processor and perform any of the methods described herein.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1A is a schematic illustration of an example of a user wearing a wearable apparatus according to a disclosed embodiment.

FIG. 1B is a schematic illustration of an example of the user wearing a wearable apparatus according to a disclosed embodiment.

FIG. 1C is a schematic illustration of an example of the user wearing a wearable apparatus according to a disclosed embodiment.

FIG. 1D is a schematic illustration of an example of the user wearing a wearable apparatus according to a disclosed embodiment.

FIG. 2 is a schematic illustration of an example system consistent with the disclosed embodiments.

FIG. 3A is a schematic illustration of an example of the wearable apparatus shown in FIG. 1A.

FIG. 3B is an exploded view of the example of the wearable apparatus shown in FIG. 3A.

FIG. 4A-4K are schematic illustrations of an example of the wearable apparatus shown in FIG. 1B from various viewpoints.

FIG. 5A is a block diagram illustrating an example of the components of a wearable apparatus according to a first embodiment.

FIG. 5B is a block diagram illustrating an example of the components of a wearable apparatus according to a second embodiment.

FIG. 5C is a block diagram illustrating an example of the components of a wearable apparatus according to a third embodiment.

FIG. 6 illustrates an exemplary embodiment of a memory containing software modules consistent with the present disclosure.

FIG. 7 is a schematic illustration of an embodiment of a wearable apparatus including an orientable image capture unit.

FIG. 8 is a schematic illustration of an embodiment of a wearable apparatus securable to an article of clothing consistent with the present disclosure.

FIG. 9 is a schematic illustration of a user wearing a wearable apparatus consistent with an embodiment of the present disclosure.

FIG. 10 is a schematic illustration of an embodiment of a wearable apparatus securable to an article of clothing consistent with the present disclosure.

FIG. 11 is a schematic illustration of an embodiment of a wearable apparatus securable to an article of clothing consistent with the present disclosure.

FIG. 12 is a schematic illustration of an embodiment of a wearable apparatus securable to an article of clothing consistent with the present disclosure.

FIG. 13 is a schematic illustration of an embodiment of a wearable apparatus securable to an article of clothing consistent with the present disclosure.

FIG. 14 is a schematic illustration of an embodiment of a wearable apparatus securable to an article of clothing consistent with the present disclosure.

FIG. 15 is a schematic illustration of an embodiment of a wearable apparatus power unit including a power source.

FIG. 16 is a schematic illustration of an exemplary embodiment of a wearable apparatus including protective circuitry.

FIG. 17 is a block diagram illustrating components of wearable apparatus, consistent with the disclosed embodiments.

FIG. 18 is an illustration of an example image that may be used for selectively reading text, consistent with the disclosed embodiments.

FIGS. 19 and 20 illustrate example documents that may be analyzed for selectively reading text, consistent with the disclosed embodiments.

FIG. 21 is a flowchart showing an example process for selectively reading text, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

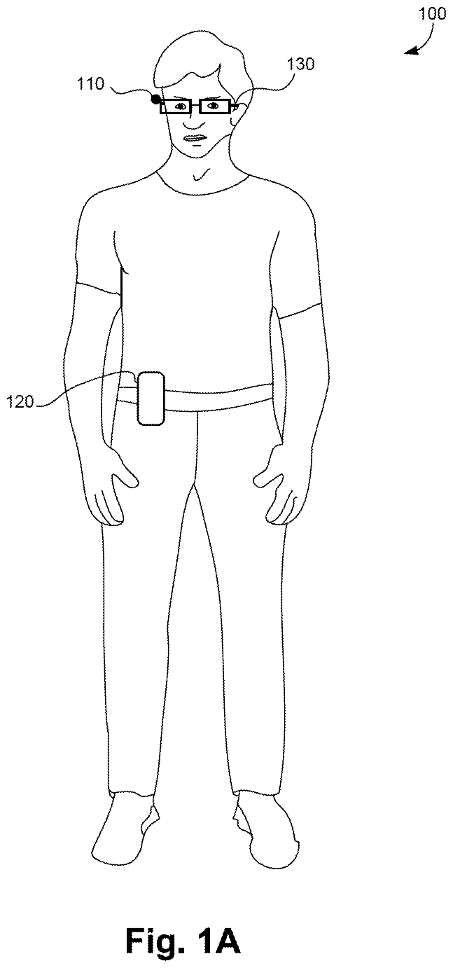

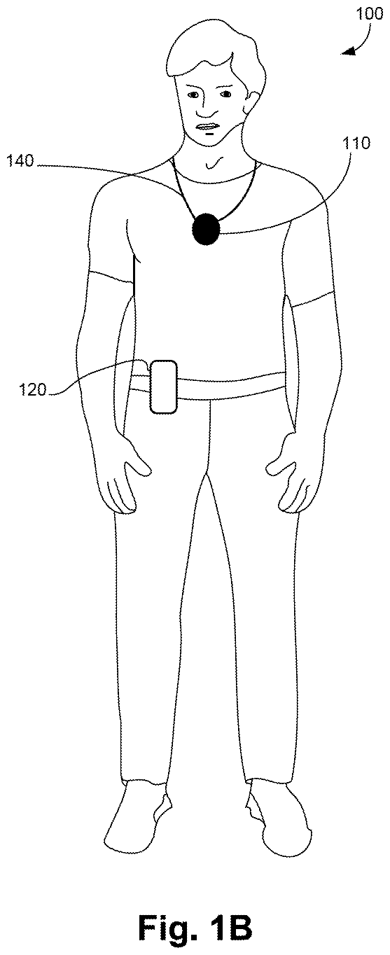

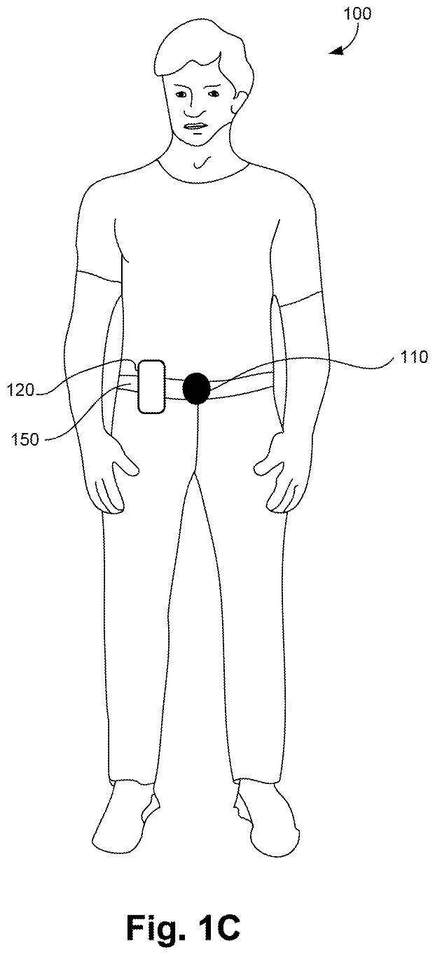

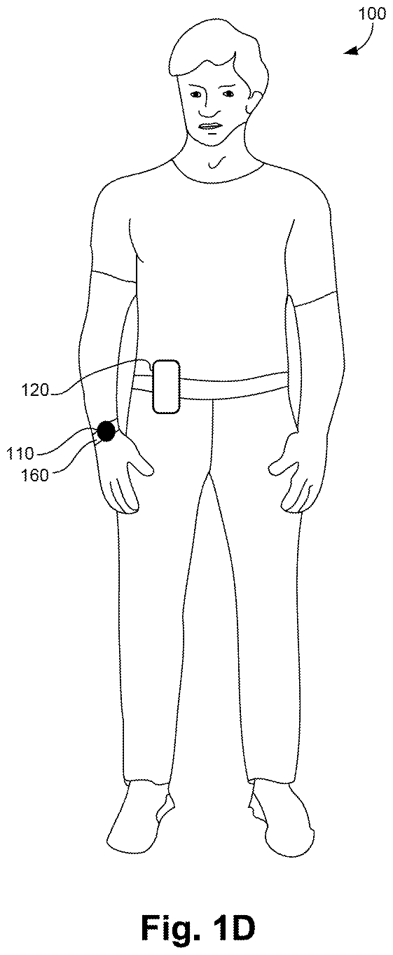

FIG. 1A illustrates a user 100 wearing an apparatus 110 that is physically connected (or integral) to glasses 130, consistent with the disclosed embodiments. Glasses 130 may be prescription glasses, magnifying glasses, non-prescription glasses, safety glasses, sunglasses, etc. Additionally, in some embodiments, glasses 130 may include parts of a frame and earpieces, nosepieces, etc., and one or no lenses. Thus, in some embodiments, glasses 130 may function primarily to support apparatus 110, and/or an augmented reality display device or other optical display device. In some embodiments, apparatus 110 may include an image sensor (not shown in FIG. 1A) for capturing real-time image data of the field-of-view of user 100. The term “image data” includes any form of data retrieved from optical signals in the near-infrared, infrared, visible, and ultraviolet spectrums. The image data may include video clips and/or photographs.

In some embodiments, apparatus 110 may communicate wirelessly or via a wire with a computing device 120. In some embodiments, computing device 120 may include, for example, a smartphone, or a tablet, or a dedicated processing unit, which may be portable (e.g., can be carried in a pocket of user 100). Although shown in FIG. 1A as an external device, in some embodiments, computing device 120 may be provided as part of wearable apparatus 110 or glasses 130, whether integral thereto or mounted thereon. In some embodiments, computing device 120 may be included in an augmented reality display device or optical head mounted display provided integrally or mounted to glasses 130. In other embodiments, computing device 120 may be provided as part of another wearable or portable apparatus of user 100 including a wrist-strap, a multifunctional watch, a button, a clip-on, etc. And in other embodiments, computing device 120 may be provided as part of another system, such as an on-board automobile computing or navigation system. A person skilled in the art can appreciate that different types of computing devices and arrangements of devices may implement the functionality of the disclosed embodiments. Accordingly, in other implementations, computing device 120 may include a Personal Computer (PC), laptop, an Internet server, etc.

FIG. 1B illustrates user 100 wearing apparatus 110 that is physically connected to a necklace 140, consistent with a disclosed embodiment. Such a configuration of apparatus 110 may be suitable for users that do not wear glasses some or all of the time. In this embodiment, user 100 can easily wear apparatus 110, and take it off.

FIG. 1C illustrates user 100 wearing apparatus 110 that is physically connected to a belt 150, consistent with a disclosed embodiment. Such a configuration of apparatus 110 may be designed as a belt buckle. Alternatively, apparatus 110 may include a clip for attaching to various clothing articles, such as belt 150, or a vest, a pocket, a collar, a cap or hat or other portion of a clothing article.

FIG. 1D illustrates user 100 wearing apparatus 110 that is physically connected to a wrist strap 160, consistent with a disclosed embodiment. Although the aiming direction of apparatus 110, according to this embodiment, may not match the field-of-view of user 100, apparatus 110 may include the ability to identify a hand-related trigger based on the tracked eye movement of a user 100 indicating that user 100 is looking in the direction of the wrist strap 160. Wrist strap 160 may also include an accelerometer, a gyroscope, or other sensor for determining movement or orientation of a user's 100 hand for identifying a hand-related trigger.

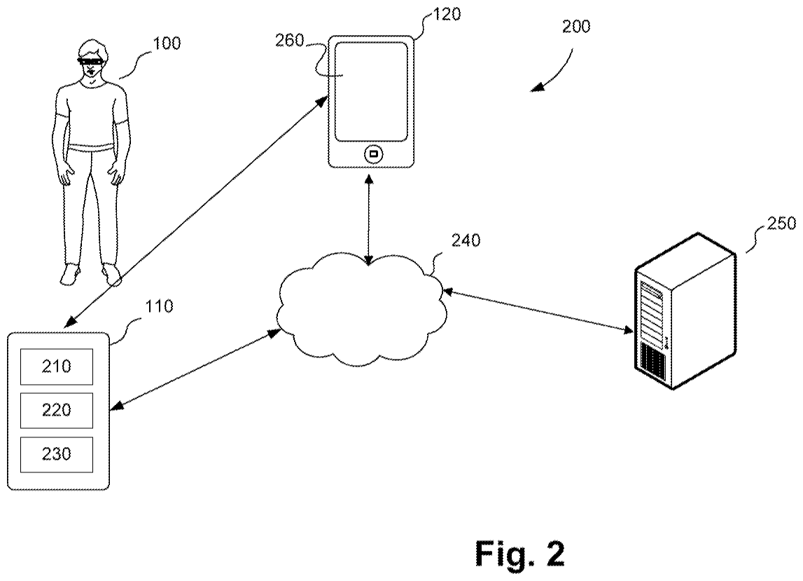

FIG. 2 is a schematic illustration of an exemplary system 200 including a wearable apparatus 110, worn by user 100, and an optional computing device 120 and/or a server 250 capable of communicating with apparatus 110 via a network 240, consistent with disclosed embodiments. In some embodiments, apparatus 110 may capture and analyze image data, identify a hand-related trigger present in the image data, and perform an action and/or provide feedback to a user 100, based at least in part on the identification of the hand-related trigger. In some embodiments, optional computing device 120 and/or server 250 may provide additional functionality to enhance interactions of user 100 with his or her environment, as described in greater detail below.

According to the disclosed embodiments, apparatus 110 may include an image sensor system 220 for capturing real-time image data of the field-of-view of user 100. In some embodiments, apparatus 110 may also include a processing unit 210 for controlling and performing the disclosed functionality of apparatus 110, such as to control the capture of image data, analyze the image data, and perform an action and/or output a feedback based on a hand-related trigger identified in the image data. According to the disclosed embodiments, a hand-related trigger may include a gesture performed by user 100 involving a portion of a hand of user 100. Further, consistent with some embodiments, a hand-related trigger may include a wrist-related trigger. Additionally, in some embodiments, apparatus 110 may include a feedback outputting unit 230 for producing an output of information to user 100.

As discussed above, apparatus 110 may include an image sensor 220 for capturing image data. The term “image sensor” refers to a device capable of detecting and converting optical signals in the near-infrared, infrared, visible, and ultraviolet spectrums into electrical signals. The electrical signals may be used to form an image or a video stream (i.e. image data) based on the detected signal. The term “image data” includes any form of data retrieved from optical signals in the near-infrared, infrared, visible, and ultraviolet spectrums. Examples of image sensors may include semiconductor charge-coupled devices (CCD), active pixel sensors in complementary metal-oxide-semiconductor (CMOS), or N-type metal-oxide-semiconductor (NMOS, Live MOS). In some cases, image sensor 220 may be part of a camera included in apparatus 110.

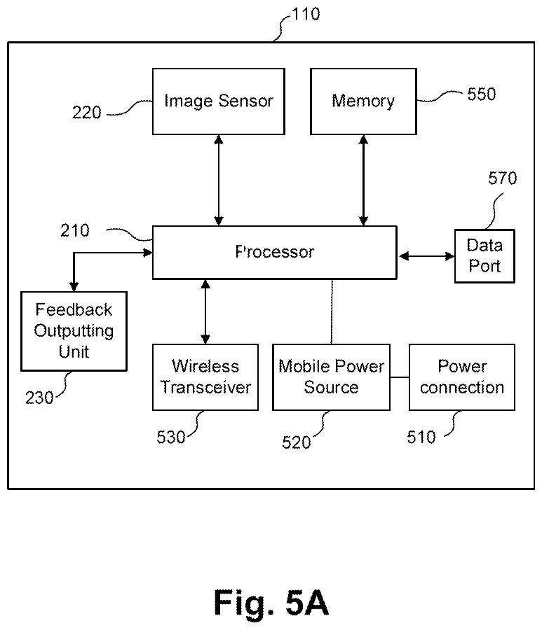

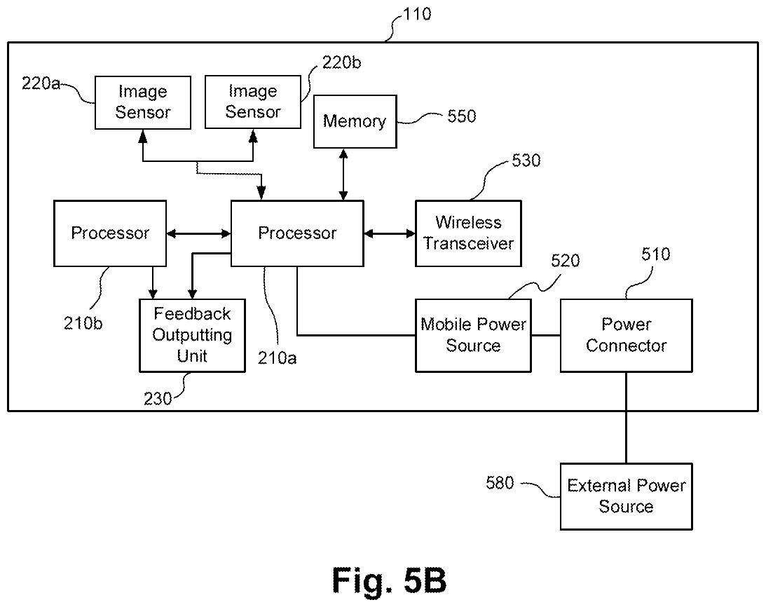

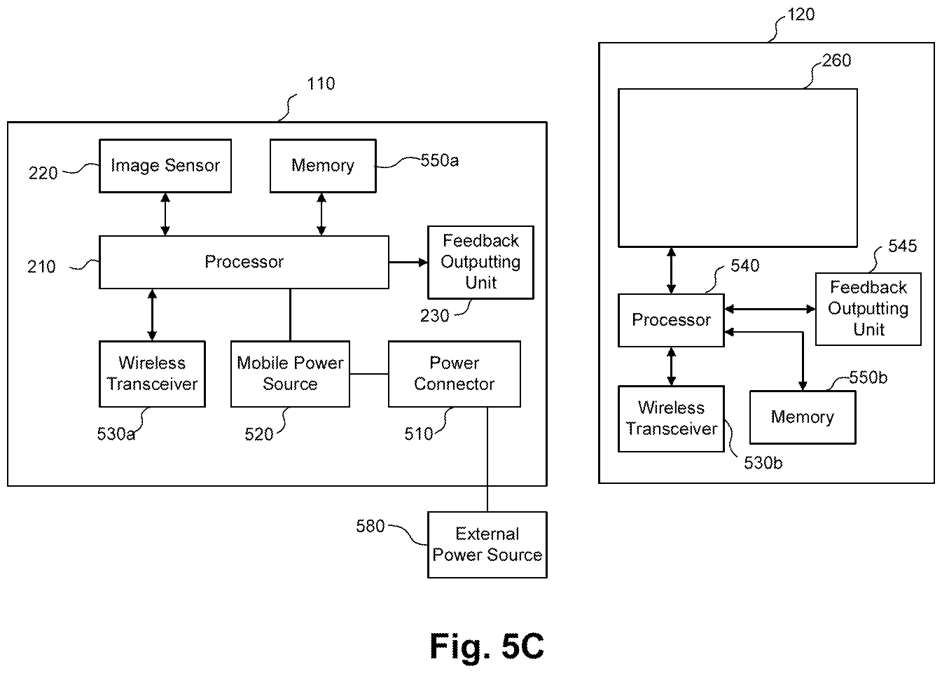

Apparatus 110 may also include a processor 210 for controlling image sensor 220 to capture image data and for analyzing the image data according to the disclosed embodiments. As discussed in further detail below with respect to FIG. 5A, processor 210 may include a “processing device” for performing logic operations on one or more inputs of image data and other data according to stored or accessible software instructions providing desired functionality. In some embodiments, processor 210 may also control feedback outputting unit 230 to provide feedback to user 100 including information based on the analyzed image data and the stored software instructions. As the term is used herein, a “processing device” may access memory where executable instructions are stored or, in some embodiments, a “processing device” itself may include executable instructions (e.g., stored in memory included in the processing device).

In some embodiments, the information or feedback information provided to user 100 may include time information. The time information may include any information related to a current time of day and, as described further below, may be presented in any sensory perceptive manner. In some embodiments, time information may include a current time of day in a preconfigured format (e.g., 2:30 pm or 14:30). Time information may include the time in the user's current time zone (e.g., based on a determined location of user 100), as well as an indication of the time zone and/or a time of day in another desired location. In some embodiments, time information may include a number of hours or minutes relative to one or more predetermined times of day. For example, in some embodiments, time information may include an indication that three hours and fifteen minutes remain until a particular hour (e.g., until 6:00 pm), or some other predetermined time. Time information may also include a duration of time passed since the beginning of a particular activity, such as the start of a meeting or the start of a jog, or any other activity. In some embodiments, the activity may be determined based on analyzed image data. In other embodiments, time information may also include additional information related to a current time and one or more other routine, periodic, or scheduled events. For example, time information may include an indication of the number of minutes remaining until the next scheduled event, as may be determined from a calendar function or other information retrieved from computing device 120 or server 250, as discussed in further detail below.

Feedback outputting unit 230 may include one or more feedback systems for providing the output of information to user 100. In the disclosed embodiments, the audible or visual feedback may be provided via any type of connected audible or visual system or both. Feedback of information according to the disclosed embodiments may include audible feedback to user 100 (e.g., using a Bluetooth™ or other wired or wirelessly connected speaker, or a bone conduction headphone). Feedback outputting unit 230 of some embodiments may additionally or alternatively produce a visible output of information to user 100, for example, as part of an augmented reality display projected onto a lens of glasses 130 or provided via a separate heads up display in communication with apparatus 110, such as a display 260 provided as part of computing device 120, which may include an onboard automobile heads up display, an augmented reality device, a virtual reality device, a smartphone, PC, table, etc.

The term “computing device” refers to a device including a processing unit and having computing capabilities. Some examples of computing device 120 include a PC, laptop, tablet, or other computing systems such as an on-board computing system of an automobile, for example, each configured to communicate directly with apparatus 110 or server 250 over network 240. Another example of computing device 120 includes a smartphone having a display 260. In some embodiments, computing device 120 may be a computing system configured particularly for apparatus 110, and may be provided integral to apparatus 110 or tethered thereto. Apparatus 110 can also connect to computing device 120 over network 240 via any known wireless standard (e.g., Wi-Fi, Bluetooth®, etc.), as well as near-filed capacitive coupling, and other short range wireless techniques, or via a wired connection. In an embodiment in which computing device 120 is a smartphone, computing device 120 may have a dedicated application installed therein. For example, user 100 may view on display 260 data (e.g., images, video clips, extracted information, feedback information, etc.) that originate from or are triggered by apparatus 110. In addition, user 100 may select part of the data for storage in server 250.

Network 240 may be a shared, public, or private network, may encompass a wide area or local area, and may be implemented through any suitable combination of wired and/or wireless communication networks. Network 240 may further comprise an intranet or the Internet. In some embodiments, network 240 may include short range or near-field wireless communication systems for enabling communication between apparatus 110 and computing device 120 provided in close proximity to each other, such as on or near a user's person, for example. Apparatus 110 may establish a connection to network 240 autonomously, for example, using a wireless module (e.g., Wi-Fi, cellular). In some embodiments, apparatus 110 may use the wireless module when being connected to an external power source, to prolong battery life. Further, communication between apparatus 110 and server 250 may be accomplished through any suitable communication channels, such as, for example, a telephone network, an extranet, an intranet, the Internet, satellite communications, off-line communications, wireless communications, transponder communications, a local area network (LAN), a wide area network (WAN), and a virtual private network (VPN).

As shown in FIG. 2, apparatus 110 may transfer or receive data to/from server 250 via network 240. In the disclosed embodiments, the data being received from server 250 and/or computing device 120 may include numerous different types of information based on the analyzed image data, including information related to a commercial product, or a person's identity, an identified landmark, and any other information capable of being stored in or accessed by server 250. In some embodiments, data may be received and transferred via computing device 120. Server 250 and/or computing device 120 may retrieve information from different data sources (e.g., a user specific database or a user's social network account or other account, the Internet, and other managed or accessible databases) and provide information to apparatus 110 related to the analyzed image data and a recognized trigger according to the disclosed embodiments. In some embodiments, calendar-related information retrieved from the different data sources may be analyzed to provide certain time information or a time-based context for providing certain information based on the analyzed image data.

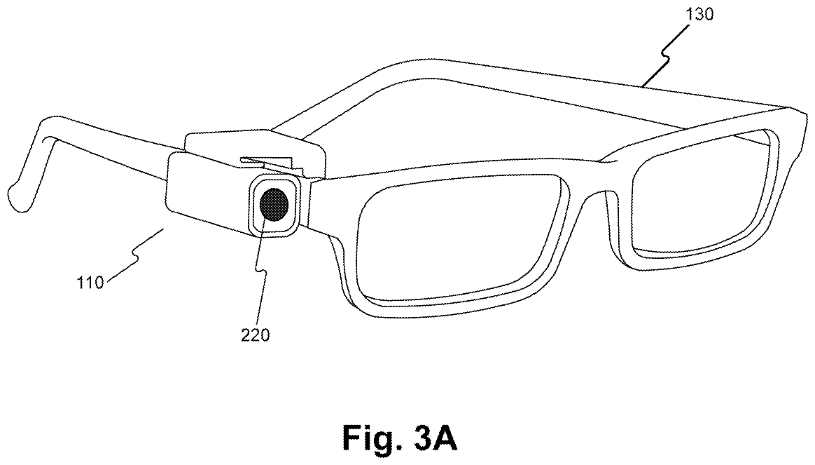

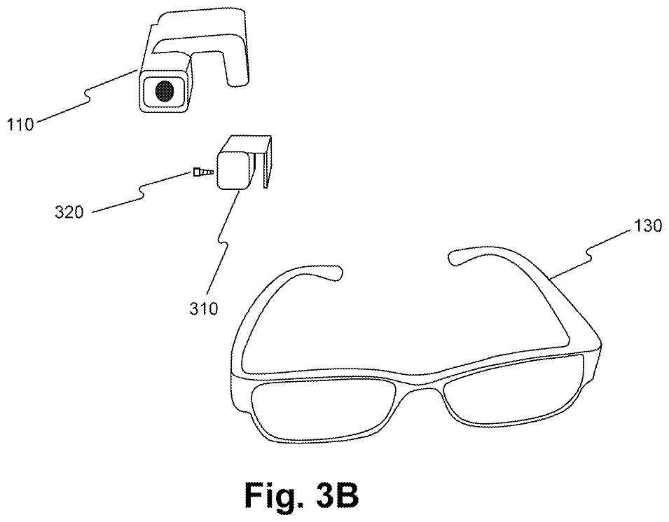

An example of wearable apparatus 110 incorporated with glasses 130 according to some embodiments (as discussed in connection with FIG. 1A) is shown in greater detail in FIG. 3A. In some embodiments, apparatus 110 may be associated with a structure (not shown in FIG. 3A) that enables easy detaching and reattaching of apparatus 110 to glasses 130. In some embodiments, when apparatus 110 attaches to glasses 130, image sensor 220 acquires a set aiming direction without the need for directional calibration. The set aiming direction of image sensor 220 may substantially coincide with the field-of-view of user 100. For example, a camera associated with image sensor 220 may be installed within apparatus 110 in a predetermined angle in a position facing slightly downwards (e.g., 5-15 degrees from the horizon). Accordingly, the set aiming direction of image sensor 220 may substantially match the field-of-view of user 100.

FIG. 3B is an exploded view of the components of the embodiment discussed regarding FIG. 3A. Attaching apparatus 110 to glasses 130 may take place in the following way. Initially, a support 310 may be mounted on glasses 130 using a screw 320, in the side of support 310. Then, apparatus 110 may be clipped on support 310 such that it is aligned with the field-of-view of user 100. The term “support” includes any device or structure that enables detaching and reattaching of a device including a camera to a pair of glasses or to another object (e.g., a helmet). Support 310 may be made from plastic (e.g., polycarbonate), metal (e.g., aluminum), or a combination of plastic and metal (e.g., carbon fiber graphite). Support 310 may be mounted on any kind of glasses (e.g., eyeglasses, sunglasses, 3D glasses, safety glasses, etc.) using screws, bolts, snaps, or any fastening means used in the art.

In some embodiments, support 310 may include a quick release mechanism for disengaging and reengaging apparatus 110. For example, support 310 and apparatus 110 may include magnetic elements. As an alternative example, support 310 may include a male latch member and apparatus 110 may include a female receptacle. In other embodiments, support 310 can be an integral part of a pair of glasses, or sold separately and installed by an optometrist. For example, support 310 may be configured for mounting on the arms of glasses 130 near the frame front, but before the hinge. Alternatively, support 310 may be configured for mounting on the bridge of glasses 130.

In some embodiments, apparatus 110 may be provided as part of a glasses frame 130, with or without lenses. Additionally, in some embodiments, apparatus 110 may be configured to provide an augmented reality display projected onto a lens of glasses 130 (if provided), or alternatively, may include a display for projecting time information, for example, according to the disclosed embodiments. Apparatus 110 may include the additional display or alternatively, may be in communication with a separately provided display system that may or may not be attached to glasses 130.

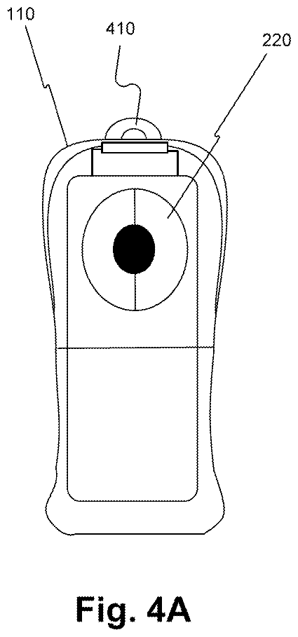

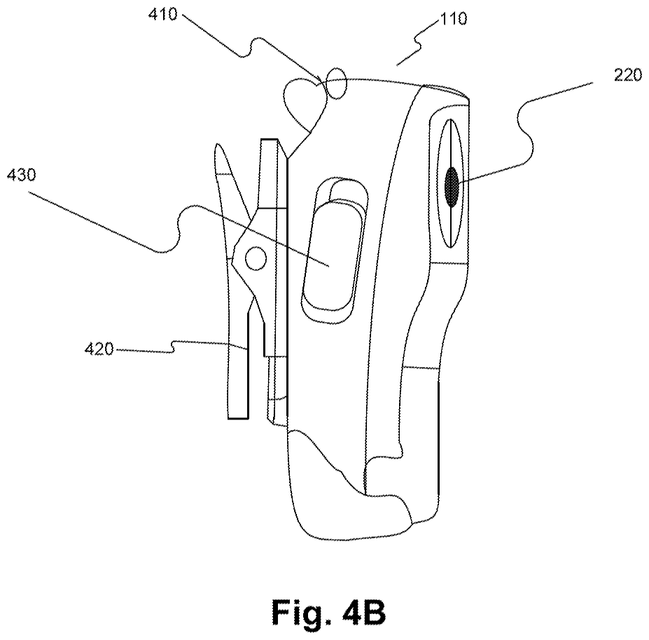

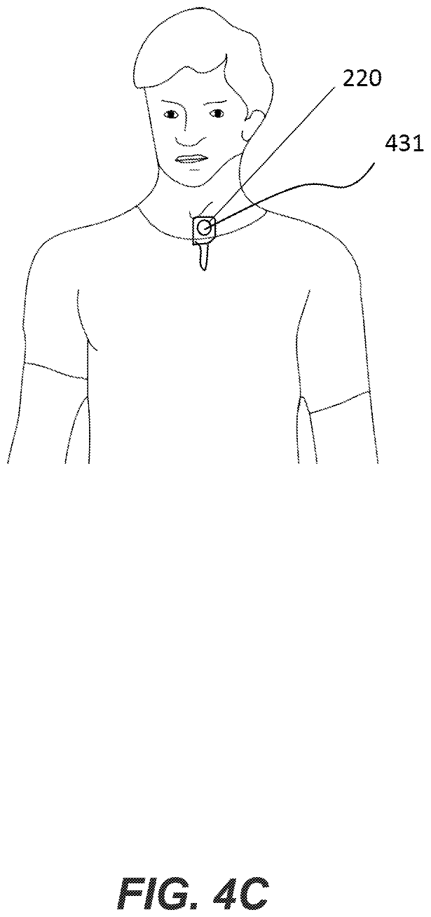

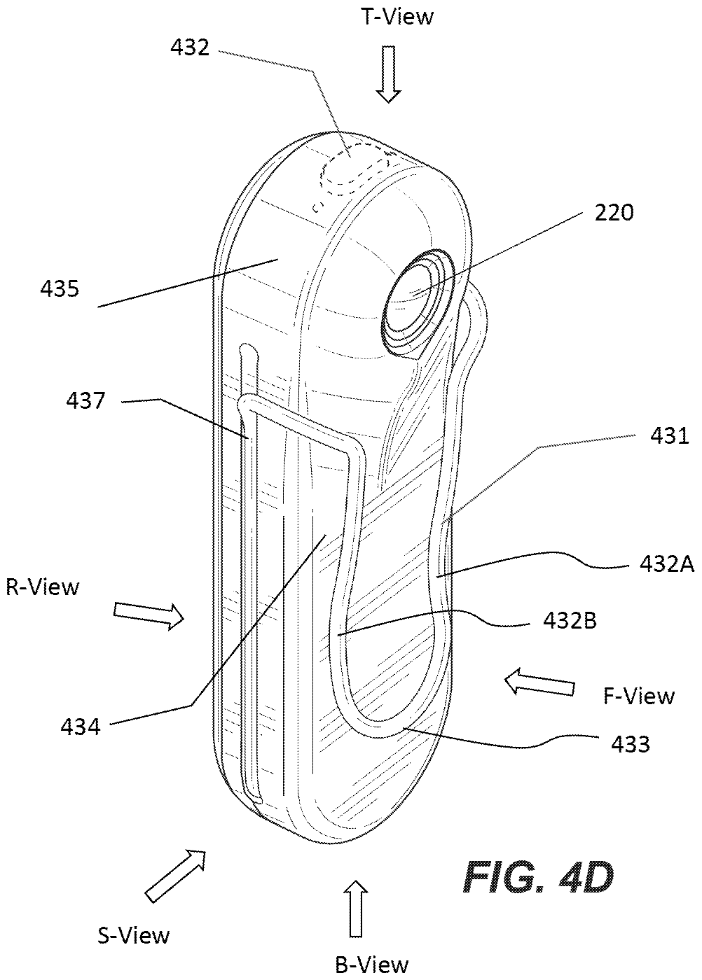

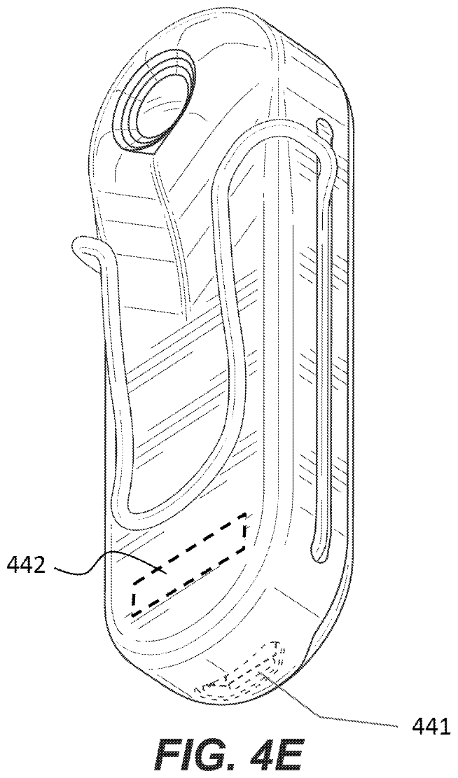

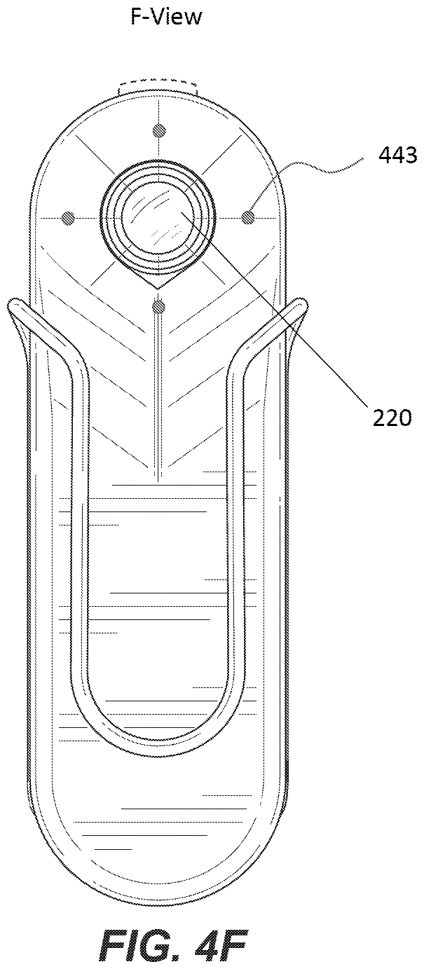

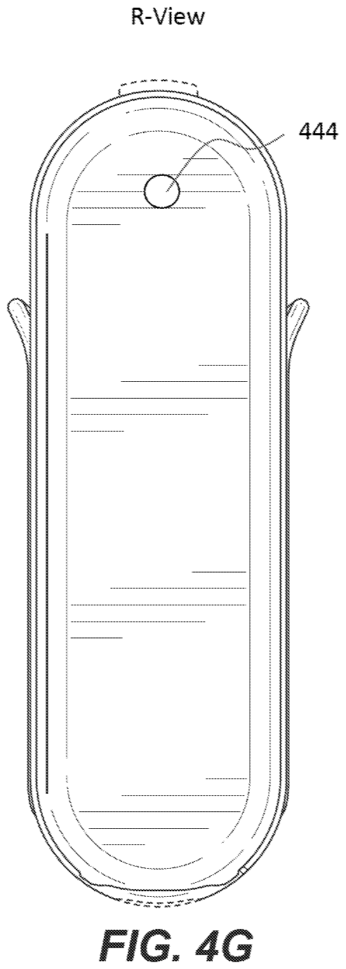

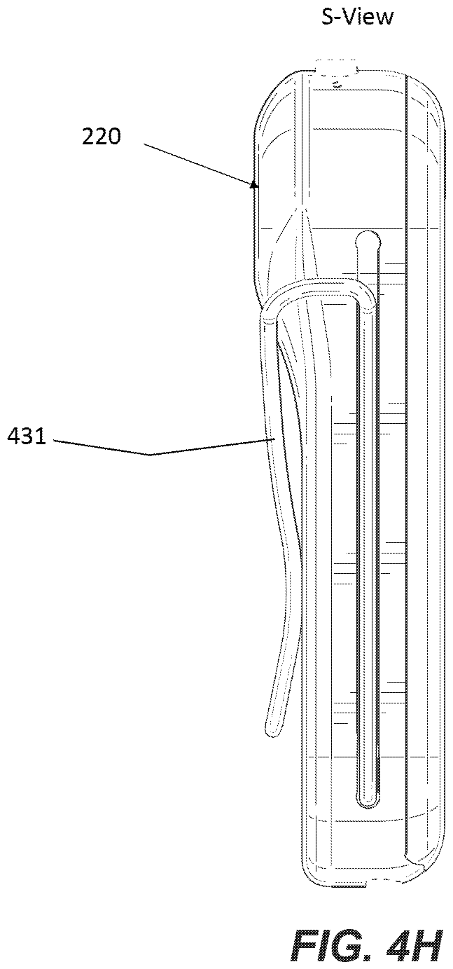

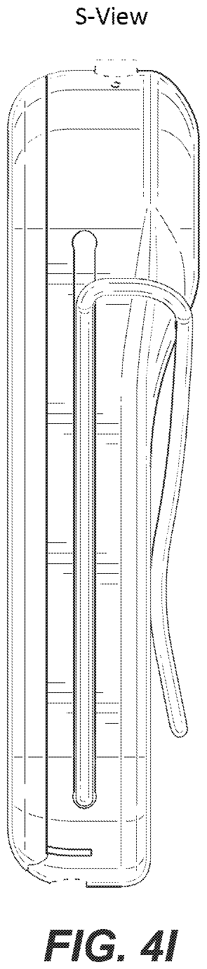

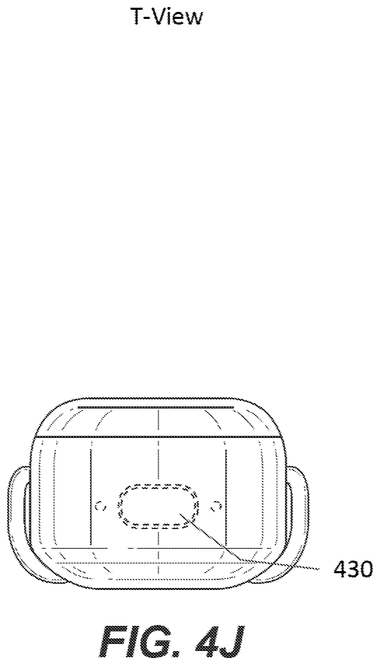

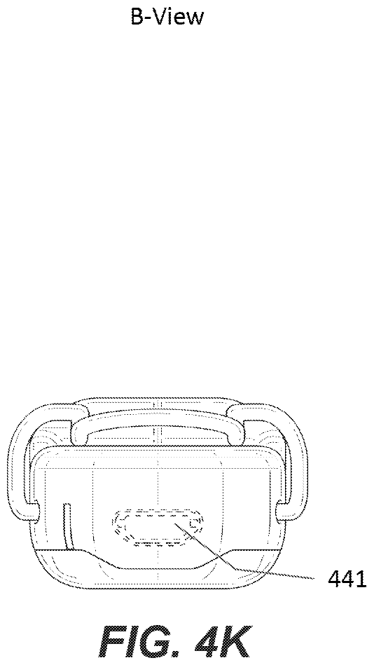

In some embodiments, apparatus 110 may be implemented in a form other than wearable glasses, as described above with respect to FIGS. 1B-1D, for example FIG. 4A is a schematic illustration of an example of an additional embodiment of apparatus 110 from a front viewpoint of apparatus 110. Apparatus 110 includes an image sensor 220, a clip (not shown), a function button (not shown) and a hanging ring 410 for attaching apparatus 110 to, for example, necklace 140, as shown in FIG. 1B. When apparatus 110 hangs on necklace 140, the aiming direction of image sensor 220 may not fully coincide with the field-of-view of user 100, but the aiming direction would still correlate with the field-of-view of user 100.

FIG. 4B is a schematic illustration of the example of a second embodiment of apparatus 110, from a side orientation of apparatus 110. In addition to hanging ring 410, as shown in FIG. 4B, apparatus 110 may further include a clip 420. User 100 can use clip 420 to attach apparatus 110 to a shirt or belt 150, as illustrated in FIG. 1C. Clip 420 may provide an easy mechanism for disengaging and re-engaging apparatus 110 from different articles of clothing. In other embodiments, apparatus 110 may include a female receptacle for connecting with a male latch of a car mount or universal stand.

In some embodiments, apparatus 110 includes a function button 430 for enabling user 100 to provide input to apparatus 110. Function button 430 may accept different types of tactile input (e.g., a tap, a click, a double-click, a long press, a right-to-left slide, a left-to-right slide). In some embodiments, each type of input may be associated with a different action. For example, a tap may be associated with the function of taking a picture, while a right-to-left slide may be associated with the function of recording a video.

Apparatus 110 may be attached to an article of clothing (e.g., a shirt, a belt, pants, etc.), of user 100 at an edge of the clothing using a clip 431 as shown in FIG. 4C. For example, the body of apparatus 100 may reside adjacent to the inside surface of the clothing with clip 431 engaging with the outside surface of the clothing. In such an embodiment, as shown in FIG. 4C, the image sensor 220 (e.g., a camera for visible light) may be protruding beyond the edge of the clothing. Alternatively, clip 431 may be engaging with the inside surface of the clothing with the body of apparatus 110 being adjacent to the outside of the clothing. In various embodiments, the clothing may be positioned between clip 431 and the body of apparatus 110.

An example embodiment of apparatus 110 is shown in FIG. 4D. Apparatus 110 includes clip 431 which may include points (e.g., 432A and 432B) in close proximity to a front surface 434 of a body 435 of apparatus 110. In an example embodiment, the distance between points 432A, 432B and front surface 434 may be less than a typical thickness of a fabric of the clothing of user 100. For example, the distance between points 432A, 432B and surface 434 may be less than a thickness of a tee-shirt, e.g., less than a millimeter, less than 2 millimeters, less than 3 millimeters, etc., or, in some cases, points 432A, 432B of clip 431 may touch surface 434. In various embodiments, clip 431 may include a point 433 that does not touch surface 434, allowing the clothing to be inserted between clip 431 and surface 434.

FIG. 4D shows schematically different views of apparatus 110 defined as a front view (F-view), a rearview (R-view), a top view (T-view), a side view (S-view) and a bottom view (B-view). These views will be referred to when describing apparatus 110 in subsequent figures. FIG. 4D shows an example embodiment where clip 431 is positioned at the same side of apparatus 110 as sensor 220 (e.g., the front side of apparatus 110). Alternatively, clip 431 may be positioned at an opposite side of apparatus 110 as sensor 220 (e.g., the rear side of apparatus 110). In various embodiments, apparatus 110 may include function button 430, as shown in FIG. 4D.

Various views of apparatus 110 are illustrated in FIGS. 4E through 4K. For example, FIG. 4E shows a view of apparatus 110 with an electrical connection 441. Electrical connection 441 may be, for example, a USB port, that may be used to transfer data to/from apparatus 110 and provide electrical power to apparatus 110. In an example embodiment, connection 441 may be used to charge a battery 442 schematically shown in FIG. 4E. FIG. 4F shows F-view of apparatus 110, including sensor 220 and one or more microphones 443. In some embodiments, apparatus 110 may include several microphones 443 facing outwards, wherein microphones 443 are configured to obtain environmental sounds and sounds of various speakers communicating with user 100. FIG. 4G shows R-view of apparatus 110. In some embodiments, microphone 444 may be positioned at the rear side of apparatus 110, as shown in FIG. 4G. Microphone 444 may be used to detect an audio signal from user 100. It should be noted, that apparatus 110 may have microphones placed at any side (e.g., a front side, a rear side, a left side, a right side, a top side, or a bottom side) of apparatus 110. In various embodiments, some microphones may be at a first side (e.g., microphones 443 may be at the front of apparatus 110) and other microphones may be at a second side (e.g., microphone 444 may be at the back side of apparatus 110).

FIGS. 4H and 4I show different sides of apparatus 110 (i.e., S-view of apparatus 110) consisted with disclosed embodiments. For example, FIG. 4H shows the location of sensor 220 and an example shape of clip 431. FIG. 4J shows T-view of apparatus 110, including function button 430, and FIG. 4K shows B-view of apparatus 110 with electrical connection 441.

The example embodiments discussed above with respect to FIGS. 3A, 3B, 4A, and 4B are not limiting. In some embodiments, apparatus 110 may be implemented in any suitable configuration for performing the disclosed methods. For example, referring back to FIG. 2, the disclosed embodiments may implement an apparatus 110 according to any configuration including an image sensor 220 and a processor unit 210 to perform image analysis and for communicating with a feedback unit 230.

FIG. 5A is a block diagram illustrating the components of apparatus 110 according to an example embodiment. As shown in FIG. 5A, and as similarly discussed above, apparatus 110 includes an image sensor 220, a memory 550, a processor 210, a feedback outputting unit 230, a wireless transceiver 530, and a mobile power source 520. In other embodiments, apparatus 110 may also include buttons, other sensors such as a microphone, and inertial measurements devices such as accelerometers, gyroscopes, magnetometers, temperature sensors, color sensors, light sensors, etc. Apparatus 110 may further include a data port 570 and a power connection 510 with suitable interfaces for connecting with an external power source or an external device (not shown).

Processor 210, depicted in FIG. 5A, may include any suitable processing device. The term “processing device” includes any physical device having an electric circuit that performs a logic operation on input or inputs. For example, processing device may include one or more integrated circuits, microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. The instructions executed by the processing device may, for example, be pre-loaded into a memory integrated with or embedded into the processing device or may be stored in a separate memory (e.g., memory 550). Memory 550 may comprise a Random Access Memory (RAM), a Read-Only Memory (ROM), a hard disk, an optical disk, a magnetic medium, a flash memory, other permanent, fixed, or volatile memory, or any other mechanism capable of storing instructions.

Although, in the embodiment illustrated in FIG. 5A, apparatus 110 includes one processing device (e.g., processor 210), apparatus 110 may include more than one processing device. Each processing device may have a similar construction, or the processing devices may be of differing constructions that are electrically connected or disconnected from each other. For example, the processing devices may be separate circuits or integrated in a single circuit. When more than one processing device is used, the processing devices may be configured to operate independently or collaboratively. The processing devices may be coupled electrically, magnetically, optically, acoustically, mechanically or by other means that permit them to interact.

In some embodiments, processor 210 may process a plurality of images captured from the environment of user 100 to determine different parameters related to capturing subsequent images. For example, processor 210 can determine, based on information derived from captured image data, a value for at least one of the following: an image resolution, a compression ratio, a cropping parameter, frame rate, a focus point, an exposure time, an aperture size, and a light sensitivity. The determined value may be used in capturing at least one subsequent image. Additionally, processor 210 can detect images including at least one hand-related trigger in the environment of the user and perform an action and/or provide an output of information to a user via feedback outputting unit 230.

In another embodiment, processor 210 can change the aiming direction of image sensor 220. For example, when apparatus 110 is attached with clip 420, the aiming direction of image sensor 220 may not coincide with the field-of-view of user 100. Processor 210 may recognize certain situations from the analyzed image data and adjust the aiming direction of image sensor 220 to capture relevant image data. For example, in one embodiment, processor 210 may detect an interaction with another individual and sense that the individual is not fully in view, because image sensor 220 is tilted down. Responsive thereto, processor 210 may adjust the aiming direction of image sensor 220 to capture image data of the individual. Other scenarios are also contemplated where processor 210 may recognize the need to adjust an aiming direction of image sensor 220.

In some embodiments, processor 210 may communicate data to feedback-outputting unit 230, which may include any device configured to provide information to a user 100. Feedback outputting unit 230 may be provided as part of apparatus 110 (as shown) or may be provided external to apparatus 110 and communicatively coupled thereto. Feedback-outputting unit 230 may be configured to output visual or nonvisual feedback based on signals received from processor 210, such as when processor 210 recognizes a hand-related trigger in the analyzed image data.

The term “feedback” refers to any output or information provided in response to processing at least one image in an environment. In some embodiments, as similarly described above, feedback may include an audible or visible indication of time information, detected text or numerals, the value of currency, a branded product, a person's identity, the identity of a landmark or other environmental situation or condition including the street names at an intersection or the color of a traffic light, etc., as well as other information associated with each of these. For example, in some embodiments, feedback may include additional information regarding the amount of currency still needed to complete a transaction, information regarding the identified person, historical information or times and prices of admission etc. of a detected landmark etc. In some embodiments, feedback may include an audible tone, a tactile response, and/or information previously recorded by user 100. Feedback-outputting unit 230 may comprise appropriate components for outputting acoustical and tactile feedback. For example, feedback-outputting unit 230 may comprise audio headphones, a hearing aid type device, a speaker, a bone conduction headphone, interfaces that provide tactile cues, vibrotactile stimulators, etc. In some embodiments, processor 210 may communicate signals with an external feedback outputting unit 230 via a wireless transceiver 530, a wired connection, or some other communication interface. In some embodiments, feedback outputting unit 230 may also include any suitable display device for visually displaying information to user 100.

As shown in FIG. 5A, apparatus 110 includes memory 550. Memory 550 may include one or more sets of instructions accessible to processor 210 to perform the disclosed methods, including instructions for recognizing a hand-related trigger in the image data. In some embodiments memory 550 may store image data (e.g., images, videos) captured from the environment of user 100. In addition, memory 550 may store information specific to user 100, such as image representations of known individuals, favorite products, personal items, and calendar or appointment information, etc. In some embodiments, processor 210 may determine, for example, which type of image data to store based on available storage space in memory 550. In another embodiment, processor 210 may extract information from the image data stored in memory 550.

As further shown in FIG. 5A, apparatus 110 includes mobile power source 520. The term “mobile power source” includes any device capable of providing electrical power, which can be easily carried by hand (e.g., mobile power source 520 may weigh less than a pound). The mobility of the power source enables user 100 to use apparatus 110 in a variety of situations. In some embodiments, mobile power source 520 may include one or more batteries (e.g., nickel-cadmium batteries, nickel-metal hydride batteries, and lithium-ion batteries) or any other type of electrical power supply. In other embodiments, mobile power source 520 may be rechargeable and contained within a casing that holds apparatus 110. In yet other embodiments, mobile power source 520 may include one or more energy harvesting devices for converting ambient energy into electrical energy (e.g., portable solar power units, human vibration units, etc.).

Mobile power source 520 may power one or more wireless transceivers (e.g., wireless transceiver 530 in FIG. 5A). The term “wireless transceiver” refers to any device configured to exchange transmissions over an air interface by use of radio frequency, infrared frequency, magnetic field, or electric field. Wireless transceiver 530 may use any known standard to transmit and/or receive data (e.g., Wi-Fi, Bluetooth®, Bluetooth Smart, 802.15.4, or ZigBee). In some embodiments, wireless transceiver 530 may transmit data (e.g., raw image data, processed image data, extracted information) from apparatus 110 to computing device 120 and/or server 250. Wireless transceiver 530 may also receive data from computing device 120 and/or server 250. In other embodiments, wireless transceiver 530 may transmit data and instructions to an external feedback outputting unit 230.

FIG. 5B is a block diagram illustrating the components of apparatus 110 according to another example embodiment. In some embodiments, apparatus 110 includes a first image sensor 220a, a second image sensor 220b, a memory 550, a first processor 210a, a second processor 210b, a feedback outputting unit 230, a wireless transceiver 530, a mobile power source 520, and a power connector 510. In the arrangement shown in FIG. 5B, each of the image sensors may provide images in a different image resolution, or face a different direction. Alternatively, each image sensor may be associated with a different camera (e.g., a wide angle camera, a narrow angle camera, an IR camera, etc.). In some embodiments, apparatus 110 can select which image sensor to use based on various factors. For example, processor 210a may determine, based on available storage space in memory 550, to capture subsequent images in a certain resolution.

Apparatus 110 may operate in a first processing-mode and in a second processing-mode, such that the first processing-mode may consume less power than the second processing-mode. For example, in the first processing-mode, apparatus 110 may capture images and process the captured images to make real-time decisions based on an identifying hand-related trigger, for example. In the second processing-mode, apparatus 110 may extract information from stored images in memory 550 and delete images from memory 550. In some embodiments, mobile power source 520 may provide more than fifteen hours of processing in the first processing-mode and about three hours of processing in the second processing-mode. Accordingly, different processing-modes may allow mobile power source 520 to produce sufficient power for powering apparatus 110 for various time periods (e.g., more than two hours, more than four hours, more than ten hours, etc.).

In some embodiments, apparatus 110 may use first processor 210a in the first processing-mode when powered by mobile power source 520, and second processor 210b in the second processing-mode when powered by external power source 580 that is connectable via power connector 510. In other embodiments, apparatus 110 may determine, based on predefined conditions, which processors or which processing modes to use. Apparatus 110 may operate in the second processing-mode even when apparatus 110 is not powered by external power source 580. For example, apparatus 110 may determine that it should operate in the second processing-mode when apparatus 110 is not powered by external power source 580, if the available storage space in memory 550 for storing new image data is lower than a predefined threshold.

Although one wireless transceiver is depicted in FIG. 5B, apparatus 110 may include more than one wireless transceiver (e.g., two wireless transceivers). In an arrangement with more than one wireless transceiver, each of the wireless transceivers may use a different standard to transmit and/or receive data. In some embodiments, a first wireless transceiver may communicate with server 250 or computing device 120 using a cellular standard (e.g., LTE or GSM), and a second wireless transceiver may communicate with server 250 or computing device 120 using a short-range standard (e.g., Wi-Fi or Bluetooth®). In some embodiments, apparatus 110 may use the first wireless transceiver when the wearable apparatus is powered by a mobile power source included in the wearable apparatus, and use the second wireless transceiver when the wearable apparatus is powered by an external power source.

FIG. 5C is a block diagram illustrating the components of apparatus 110 according to another example embodiment including computing device 120. In this embodiment, apparatus 110 includes an image sensor 220, a memory 550a, a first processor 210, a feedback-outputting unit 230, a wireless transceiver 530a, a mobile power source 520, and a power connector 510. As further shown in FIG. 5C, computing device 120 includes a processor 540, a feedback-outputting unit 545, a memory 550b, a wireless transceiver 530b, and a display 260. One example of computing device 120 is a smartphone or tablet having a dedicated application installed therein. In other embodiments, computing device 120 may include any configuration such as an on-board automobile computing system, a PC, a laptop, and any other system consistent with the disclosed embodiments. In this example, user 100 may view feedback output in response to identification of a hand-related trigger on display 260. Additionally, user 100 may view other data (e.g., images, video clips, object information, schedule information, extracted information, etc.) on display 260. In addition, user 100 may communicate with server 250 via computing device 120.

In some embodiments, processor 210 and processor 540 are configured to extract information from captured image data. The term “extracting information” includes any process by which information associated with objects, individuals, locations, events, etc., is identified in the captured image data by any means known to those of ordinary skill in the art. In some embodiments, apparatus 110 may use the extracted information to send feedback or other real-time indications to feedback outputting unit 230 or to computing device 120. In some embodiments, processor 210 may identify in the image data the individual standing in front of user 100, and send computing device 120 the name of the individual and the last time user 100 met the individual. In another embodiment, processor 210 may identify in the image data, one or more visible triggers, including a hand-related trigger, and determine whether the trigger is associated with a person other than the user of the wearable apparatus to selectively determine whether to perform an action associated with the trigger. One such action may be to provide a feedback to user 100 via feedback-outputting unit 230 provided as part of (or in communication with) apparatus 110 or via a feedback unit 545 provided as part of computing device 120. For example, feedback-outputting unit 545 may be in communication with display 260 to cause the display 260 to visibly output information. In some embodiments, processor 210 may identify in the image data a hand-related trigger and send computing device 120 an indication of the trigger. Processor 540 may then process the received trigger information and provide an output via feedback outputting unit 545 or display 260 based on the hand-related trigger. In other embodiments, processor 540 may determine a hand-related trigger and provide suitable feedback similar to the above, based on image data received from apparatus 110. In some embodiments, processor 540 may provide instructions or other information, such as environmental information to apparatus 110 based on an identified hand-related trigger.

In some embodiments, processor 210 may identify other environmental information in the analyzed images, such as an individual standing in front user 100, and send computing device 120 information related to the analyzed information such as the name of the individual and the last time user 100 met the individual. In a different embodiment, processor 540 may extract statistical information from captured image data and forward the statistical information to server 250. For example, certain information regarding the types of items a user purchases, or the frequency a user patronizes a particular merchant, etc. may be determined by processor 540. Based on this information, server 250 may send computing device 120 coupons and discounts associated with the user's preferences.

When apparatus 110 is connected or wirelessly connected to computing device 120, apparatus 110 may transmit at least part of the image data stored in memory 550a for storage in memory 550b. In some embodiments, after computing device 120 confirms that transferring the part of image data was successful, processor 540 may delete the part of the image data. The term “delete” means that the image is marked as ‘deleted’ and other image data may be stored instead of it, but does not necessarily mean that the image data was physically removed from the memory.

As will be appreciated by a person skilled in the art having the benefit of this disclosure, numerous variations and/or modifications may be made to the disclosed embodiments. Not all components are essential for the operation of apparatus 110. Any component may be located in any appropriate apparatus and the components may be rearranged into a variety of configurations while providing the functionality of the disclosed embodiments. For example, in some embodiments, apparatus 110 may include a camera, a processor, and a wireless transceiver for sending data to another device. Therefore, the foregoing configurations are examples and, regardless of the configurations discussed above, apparatus 110 can capture, store, and/or process images.

Further, the foregoing and following description refers to storing and/or processing images or image data. In the embodiments disclosed herein, the stored and/or processed images or image data may comprise a representation of one or more images captured by image sensor 220. As the term is used herein, a “representation” of an image (or image data) may include an entire image or a portion of an image. A representation of an image (or image data) may have the same resolution or a lower resolution as the image (or image data), and/or a representation of an image (or image data) may be altered in some respect (e.g., be compressed, have a lower resolution, have one or more colors that are altered, etc.).

For example, apparatus 110 may capture an image and store a representation of the image that is compressed as a .JPG file. As another example, apparatus 110 may capture an image in color, but store a black-and-white representation of the color image. As yet another example, apparatus 110 may capture an image and store a different representation of the image (e.g., a portion of the image). For example, apparatus 110 may store a portion of an image that includes a face of a person who appears in the image, but that does not substantially include the environment surrounding the person. Similarly, apparatus 110 may, for example, store a portion of an image that includes a product that appears in the image, but does not substantially include the environment surrounding the product. As yet another example, apparatus 110 may store a representation of an image at a reduced resolution (i.e., at a resolution that is of a lower value than that of the captured image). Storing representations of images may allow apparatus 110 to save storage space in memory 550. Furthermore, processing representations of images may allow apparatus 110 to improve processing efficiency and/or help to preserve battery life.

In addition to the above, in some embodiments, any one of apparatus 110 or computing device 120, via processor 210 or 540, may further process the captured image data to provide additional functionality to recognize objects and/or gestures and/or other information in the captured image data. In some embodiments, actions may be taken based on the identified objects, gestures, or other information. In some embodiments, processor 210 or 540 may identify in the image data, one or more visible triggers, including a hand-related trigger, and determine whether the trigger is associated with a person other than the user to determine whether to perform an action associated with the trigger.

Some embodiments of the present disclosure may include an apparatus securable to an article of clothing of a user. Such an apparatus may include two portions, connectable by a connector. A capturing unit may be designed to be worn on the outside of a user's clothing, and may include an image sensor for capturing images of a user's environment. The capturing unit may be connected to or connectable to a power unit, which may be configured to house a power source and a processing device. The capturing unit may be a small device including a camera or other device for capturing images. The capturing unit may be designed to be inconspicuous and unobtrusive, and may be configured to communicate with a power unit concealed by a user's clothing. The power unit may include bulkier aspects of the system, such as transceiver antennas, at least one battery, a processing device, etc. In some embodiments, communication between the capturing unit and the power unit may be provided by a data cable included in the connector, while in other embodiments, communication may be wirelessly achieved between the capturing unit and the power unit. Some embodiments may permit alteration of the orientation of an image sensor of the capture unit, for example to better capture images of interest.

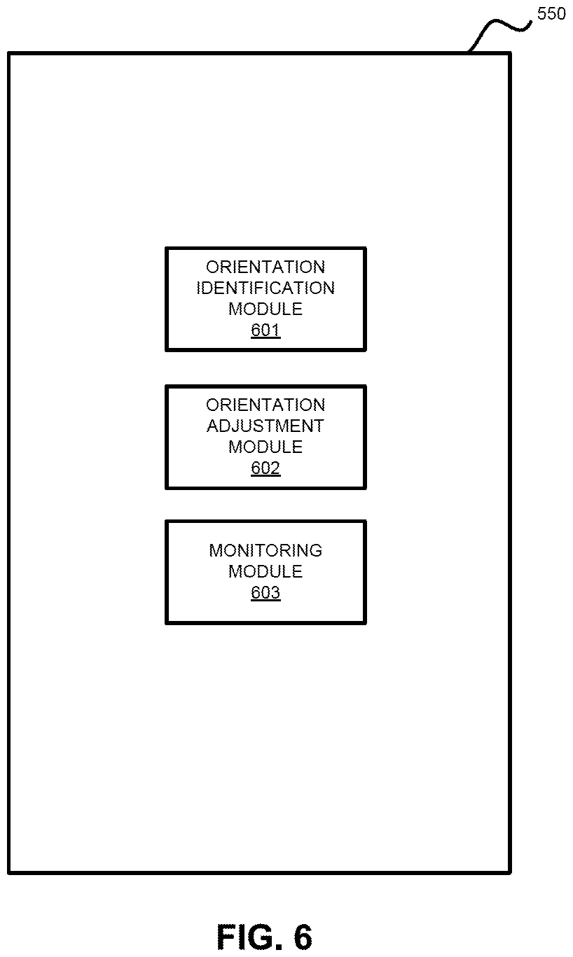

FIG. 6 illustrates an exemplary embodiment of a memory containing software modules consistent with the present disclosure. Included in memory 550 are orientation identification module 601, orientation adjustment module 602, and motion tracking module 603. Modules 601, 602, 603 may contain software instructions for execution by at least one processing device, e.g., processor 210, included with a wearable apparatus. Orientation identification module 601, orientation adjustment module 602, and motion tracking module 603 may cooperate to provide orientation adjustment for a capturing unit incorporated into wireless apparatus 110.

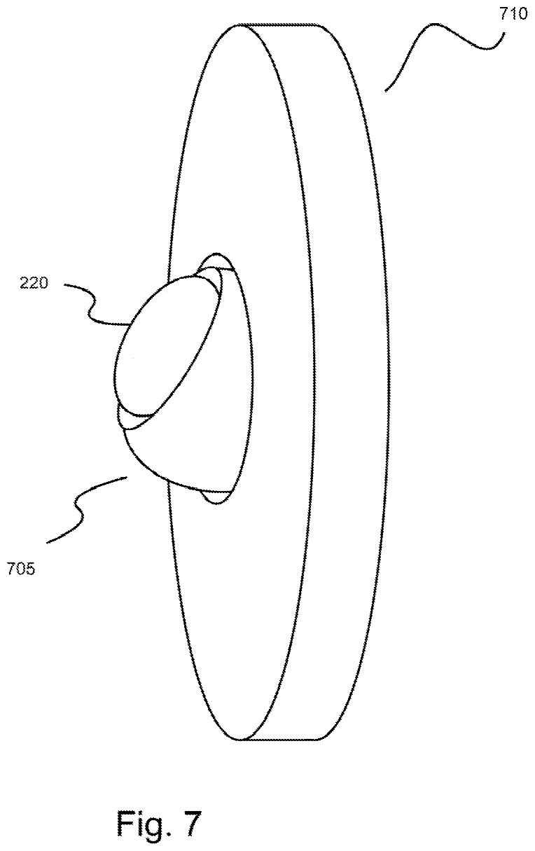

FIG. 7 illustrates an exemplary capturing unit 710 including an orientation adjustment unit 705. Orientation adjustment unit 705 may be configured to permit the adjustment of image sensor 220. As illustrated in FIG. 7, orientation adjustment unit 705 may include an eye-ball type adjustment mechanism. In alternative embodiments, orientation adjustment unit 705 may include gimbals, adjustable stalks, pivotable mounts, and any other suitable unit for adjusting an orientation of image sensor 220.

Image sensor 220 may be configured to be movable with the head of user 100 in such a manner that an aiming direction of image sensor 220 substantially coincides with a field of view of user 100. For example, as described above, a camera associated with image sensor 220 may be installed within capturing unit 710 at a predetermined angle in a position facing slightly upwards or downwards, depending on an intended location of capturing unit 710. Accordingly, the set aiming direction of image sensor 220 may match the field-of-view of user 100. In some embodiments, processor 210 may change the orientation of image sensor 220 using image data provided from image sensor 220. For example, processor 210 may recognize that a user is reading a book and determine that the aiming direction of image sensor 220 is offset from the text. That is, because the words in the beginning of each line of text are not fully in view, processor 210 may determine that image sensor 220 is tilted in the wrong direction. Responsive thereto, processor 210 may adjust the aiming direction of image sensor 220.

Orientation identification module 601 may be configured to identify an orientation of an image sensor 220 of capturing unit 710. An orientation of an image sensor 220 may be identified, for example, by analysis of images captured by image sensor 220 of capturing unit 710, by tilt or attitude sensing devices within capturing unit 710, and by measuring a relative direction of orientation adjustment unit 705 with respect to the remainder of capturing unit 710.

Orientation adjustment module 602 may be configured to adjust an orientation of image sensor 220 of capturing unit 710. As discussed above, image sensor 220 may be mounted on an orientation adjustment unit 705 configured for movement. Orientation adjustment unit 705 may be configured for rotational and/or lateral movement in response to commands from orientation adjustment module 602. In some embodiments orientation adjustment unit 705 may be adjust an orientation of image sensor 220 via motors, electromagnets, permanent magnets, and/or any suitable combination thereof.

In some embodiments, monitoring module 603 may be provided for continuous monitoring. Such continuous monitoring may include tracking a movement of at least a portion of an object included in one or more images captured by the image sensor. For example, in one embodiment, apparatus 110 may track an object as long as the object remains substantially within the field-of-view of image sensor 220. In additional embodiments, monitoring module 603 may engage orientation adjustment module 602 to instruct orientation adjustment unit 705 to continually orient image sensor 220 towards an object of interest. For example, in one embodiment, monitoring module 603 may cause image sensor 220 to adjust an orientation to ensure that a certain designated object, for example, the face of a particular person, remains within the field-of view of image sensor 220, even as that designated object moves about. In another embodiment, monitoring module 603 may continuously monitor an area of interest included in one or more images captured by the image sensor. For example, a user may be occupied by a certain task, for example, typing on a laptop, while image sensor 220 remains oriented in a particular direction and continuously monitors a portion of each image from a series of images to detect a trigger or other event. For example, image sensor 210 may be oriented towards a piece of laboratory equipment and monitoring module 603 may be configured to monitor a status light on the laboratory equipment for a change in status, while the user's attention is otherwise occupied.

In some embodiments consistent with the present disclosure, capturing unit 710 may include a plurality of image sensors 220. The plurality of image sensors 220 may each be configured to capture different image data. For example, when a plurality of image sensors 220 are provided, the image sensors 220 may capture images having different resolutions, may capture wider or narrower fields of view, and may have different levels of magnification. Image sensors 220 may be provided with varying lenses to permit these different configurations. In some embodiments, a plurality of image sensors 220 may include image sensors 220 having different orientations. Thus, each of the plurality of image sensors 220 may be pointed in a different direction to capture different images. The fields of view of image sensors 220 may be overlapping in some embodiments. The plurality of image sensors 220 may each be configured for orientation adjustment, for example, by being paired with an image adjustment unit 705. In some embodiments, monitoring module 603, or another module associated with memory 550, may be configured to individually adjust the orientations of the plurality of image sensors 220 as well as to turn each of the plurality of image sensors 220 on or off as may be required. In some embodiments, monitoring an object or person captured by an image sensor 220 may include tracking movement of the object across the fields of view of the plurality of image sensors 220.

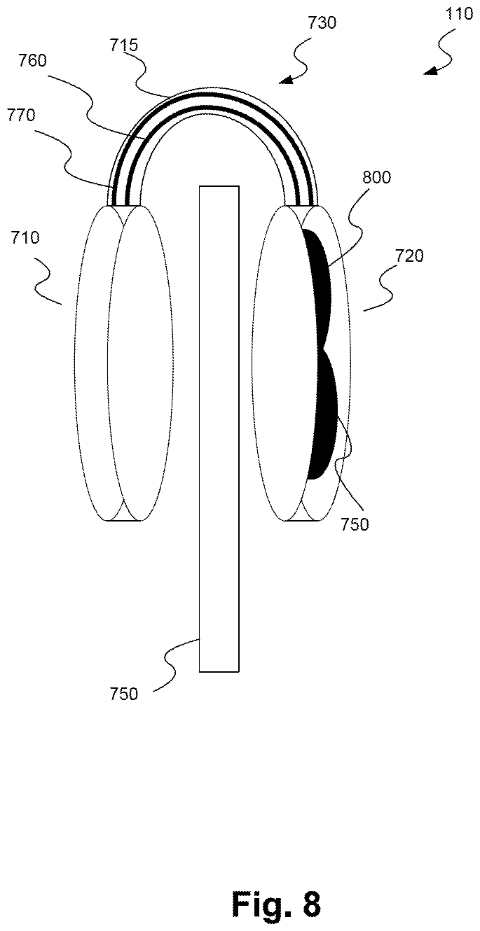

Embodiments consistent with the present disclosure may include connectors configured to connect a capturing unit and a power unit of a wearable apparatus. Capturing units consistent with the present disclosure may include least one image sensor configured to capture images of an environment of a user. Power units consistent with the present disclosure may be configured to house a power source and/or at least one processing device. Connectors consistent with the present disclosure may be configured to connect the capturing unit and the power unit, and may be configured to secure the apparatus to an article of clothing such that the capturing unit is positioned over an outer surface of the article of clothing and the power unit is positioned under an inner surface of the article of clothing. Exemplary embodiments of capturing units, connectors, and power units consistent with the disclosure are discussed in further detail with respect to FIGS. 8-14.

FIG. 8 is a schematic illustration of an embodiment of wearable apparatus 110 securable to an article of clothing consistent with the present disclosure. As illustrated in FIG. 8, capturing unit 710 and power unit 720 may be connected by a connector 730 such that capturing unit 710 is positioned on one side of an article of clothing 750 and power unit 720 is positioned on the opposite side of the clothing 750. In some embodiments, capturing unit 710 may be positioned over an outer surface of the article of clothing 750 and power unit 720 may be located under an inner surface of the article of clothing 750. The power unit 720 may be configured to be placed against the skin of a user.

Capturing unit 710 may include an image sensor 220 and an orientation adjustment unit 705 (as illustrated in FIG. 7). Power unit 720 may include mobile power source 520 and processor 210. Power unit 720 may further include any combination of elements previously discussed that may be a part of wearable apparatus 110, including, but not limited to, wireless transceiver 530, feedback outputting unit 230, memory 550, and data port 570.

Connector 730 may include a clip 715 or other mechanical connection designed to clip or attach capturing unit 710 and power unit 720 to an article of clothing 750 as illustrated in FIG. 8. As illustrated, clip 715 may connect to each of capturing unit 710 and power unit 720 at a perimeter thereof, and may wrap around an edge of the article of clothing 750 to affix the capturing unit 710 and power unit 720 in place. Connector 730 may further include a power cable 760 and a data cable 770. Power cable 760 may be capable of conveying power from mobile power source 520 to image sensor 220 of capturing unit 710. Power cable 760 may also be configured to provide power to any other elements of capturing unit 710, e.g., orientation adjustment unit 705. Data cable 770 may be capable of conveying captured image data from image sensor 220 in capturing unit 710 to processor 800 in the power unit 720. Data cable 770 may be further capable of conveying additional data between capturing unit 710 and processor 800, e.g., control instructions for orientation adjustment unit 705.

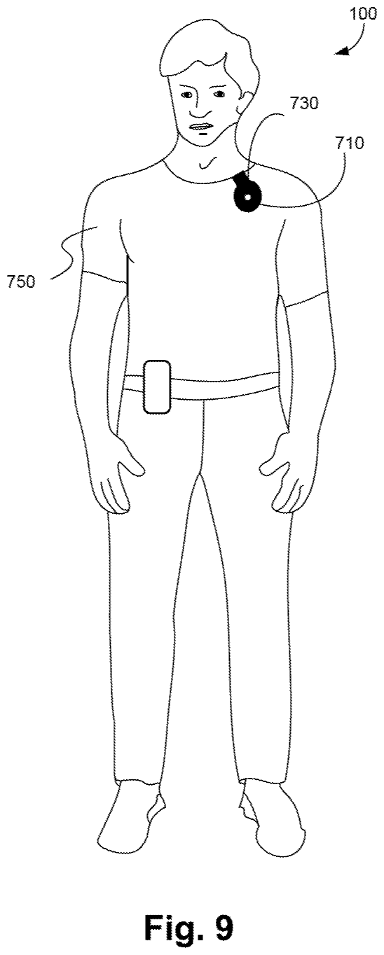

FIG. 9 is a schematic illustration of a user 100 wearing a wearable apparatus 110 consistent with an embodiment of the present disclosure. As illustrated in FIG. 9, capturing unit 710 is located on an exterior surface of the clothing 750 of user 100. Capturing unit 710 is connected to power unit 720 (not seen in this illustration) via connector 730, which wraps around an edge of clothing 750.

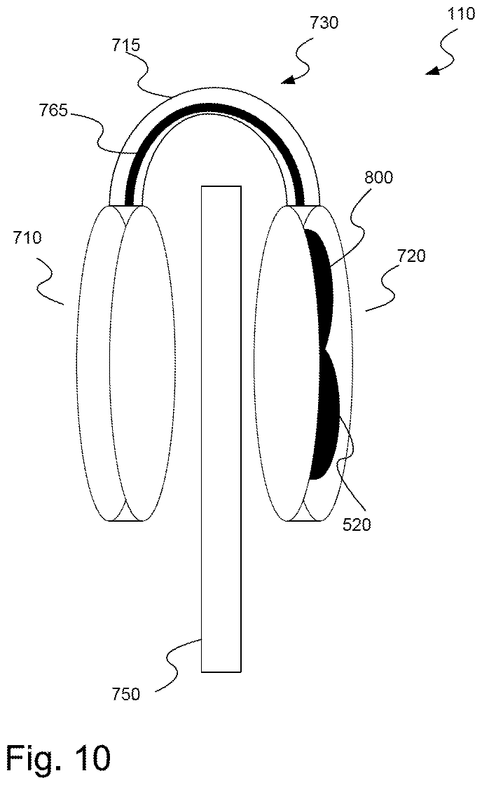

In some embodiments, connector 730 may include a flexible printed circuit board (PCB). FIG. 10 illustrates an exemplary embodiment wherein connector 730 includes a flexible printed circuit board 765. Flexible printed circuit board 765 may include data connections and power connections between capturing unit 710 and power unit 720. Thus, in some embodiments, flexible printed circuit board 765 may serve to replace power cable 760 and data cable 770. In alternative embodiments, flexible printed circuit board 765 may be included in addition to at least one of power cable 760 and data cable 770. In various embodiments discussed herein, flexible printed circuit board 765 may be substituted for, or included in addition to, power cable 760 and data cable 770.

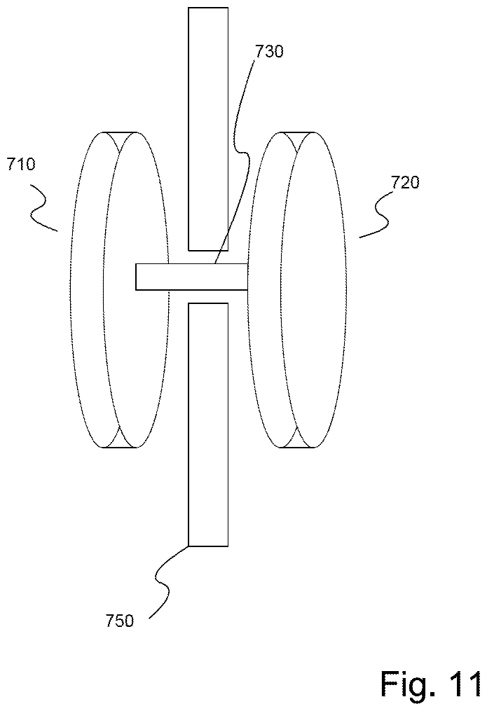

FIG. 11 is a schematic illustration of another embodiment of a wearable apparatus securable to an article of clothing consistent with the present disclosure. As illustrated in FIG. 11, connector 730 may be centrally located with respect to capturing unit 710 and power unit 720. Central location of connector 730 may facilitate affixing apparatus 110 to clothing 750 through a hole in clothing 750 such as, for example, a button-hole in an existing article of clothing 750 or a specialty hole in an article of clothing 750 designed to accommodate wearable apparatus 110.

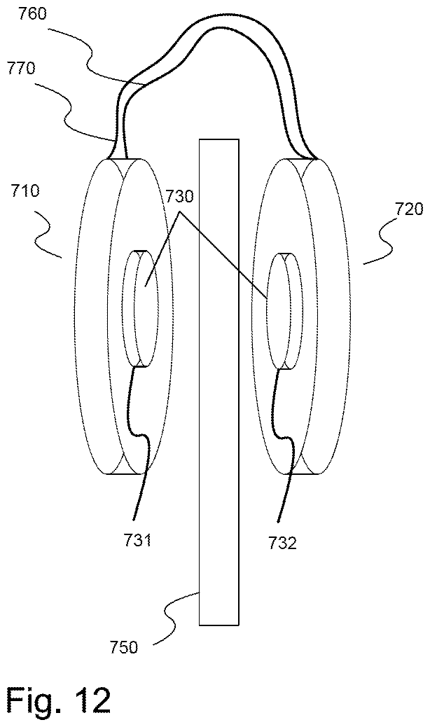

FIG. 12 is a schematic illustration of still another embodiment of wearable apparatus 110 securable to an article of clothing. As illustrated in FIG. 12, connector 730 may include a first magnet 731 and a second magnet 732. First magnet 731 and second magnet 732 may secure capturing unit 710 to power unit 720 with the article of clothing positioned between first magnet 731 and second magnet 732. In embodiments including first magnet 731 and second magnet 732, power cable 760 and data cable 770 may also be included. In these embodiments, power cable 760 and data cable 770 may be of any length, and may provide a flexible power and data connection between capturing unit 710 and power unit 720. Embodiments including first magnet 731 and second magnet 732 may further include a flexible PCB 765 connection in addition to or instead of power cable 760 and/or data cable 770. In some embodiments, first magnet 731 or second magnet 732 may be replaced by an object comprising a metal material.

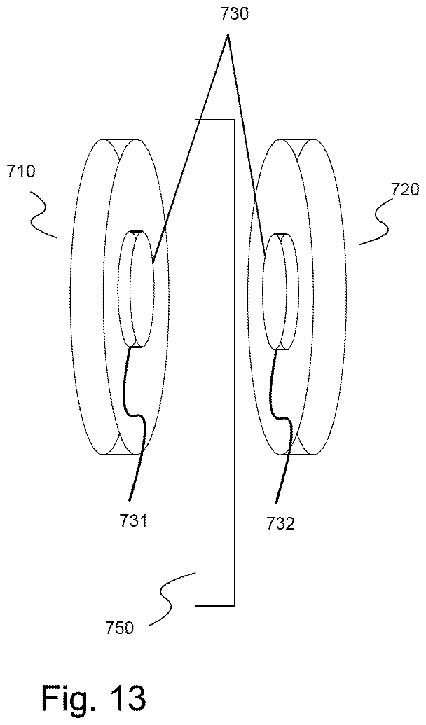

FIG. 13 is a schematic illustration of yet another embodiment of a wearable apparatus 110 securable to an article of clothing. FIG. 13 illustrates an embodiment wherein power and data may be wirelessly transferred between capturing unit 710 and power unit 720. As illustrated in FIG. 13, first magnet 731 and second magnet 732 may be provided as connector 730 to secure capturing unit 710 and power unit 720 to an article of clothing 750. Power and/or data may be transferred between capturing unit 710 and power unit 720 via any suitable wireless technology, for example, magnetic and/or capacitive coupling, near field communication technologies, radiofrequency transfer, and any other wireless technology suitable for transferring data and/or power across short distances.

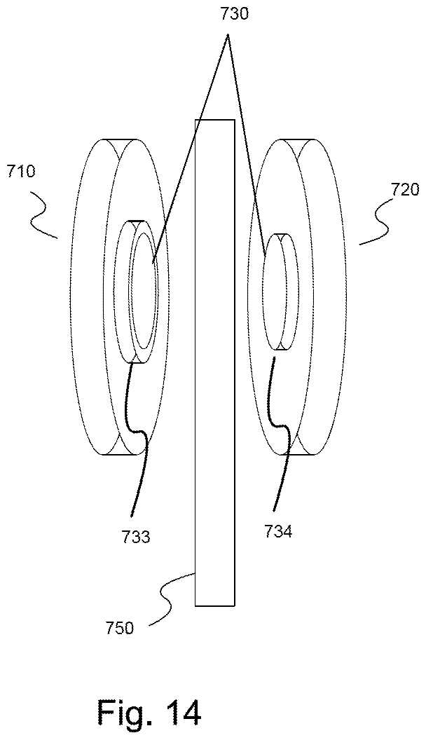

FIG. 14 illustrates still another embodiment of wearable apparatus 110 securable to an article of clothing 750 of a user. As illustrated in FIG. 14, connector 730 may include features designed for a contact fit. For example, capturing unit 710 may include a ring 733 with a hollow center having a diameter slightly larger than a disk-shaped protrusion 734 located on power unit 720. When pressed together with fabric of an article of clothing 750 between them, disk-shaped protrusion 734 may fit tightly inside ring 733, securing capturing unit 710 to power unit 720. FIG. 14 illustrates an embodiment that does not include any cabling or other physical connection between capturing unit 710 and power unit 720. In this embodiment, capturing unit 710 and power unit 720 may transfer power and data wirelessly. In alternative embodiments, capturing unit 710 and power unit 720 may transfer power and data via at least one of cable 760, data cable 770, and flexible printed circuit board 765.

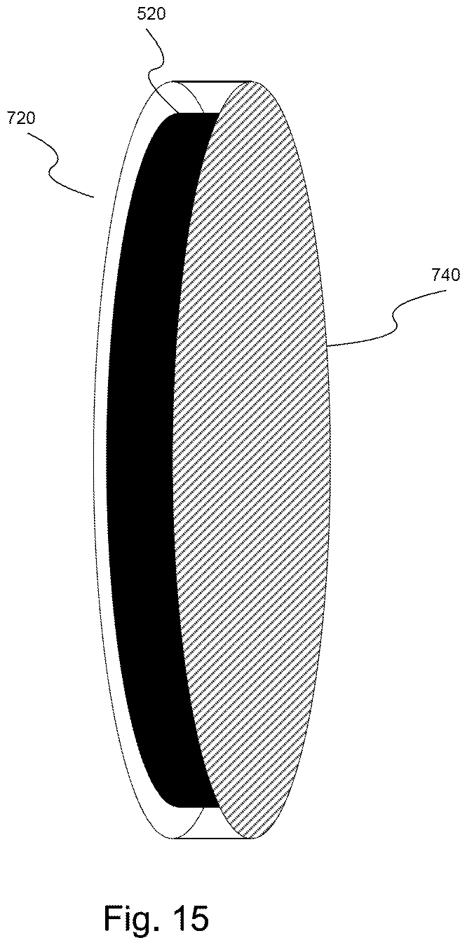

FIG. 15 illustrates another aspect of power unit 720 consistent with embodiments described herein. Power unit 720 may be configured to be positioned directly against the user's skin. To facilitate such positioning, power unit 720 may further include at least one surface coated with a biocompatible material 740. Biocompatible materials 740 may include materials that will not negatively react with the skin of the user when worn against the skin for extended periods of time. Such materials may include, for example, silicone, PTFE, kapton, polyimide, titanium, nitinol, platinum, and others. Also as illustrated in FIG. 15, power unit 720 may be sized such that an inner volume of the power unit is substantially filled by mobile power source 520. That is, in some embodiments, the inner volume of power unit 720 may be such that the volume does not accommodate any additional components except for mobile power source 520. In some embodiments, mobile power source 520 may take advantage of its close proximity to the skin of user's skin. For example, mobile power source 520 may use the Peltier effect to produce power and/or charge the power source.

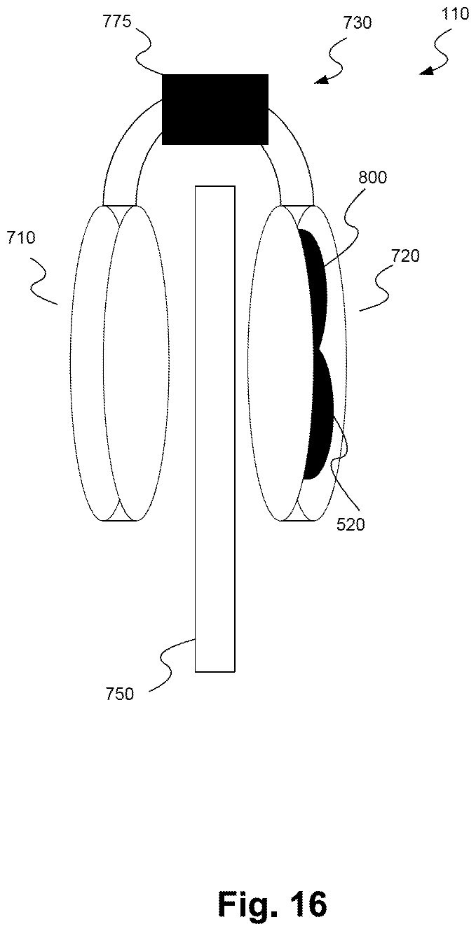

In further embodiments, an apparatus securable to an article of clothing may further include protective circuitry associated with power source 520 housed in in power unit 720. FIG. 16 illustrates an exemplary embodiment including protective circuitry 775. As illustrated in FIG. 16, protective circuitry 775 may be located remotely with respect to power unit 720. In alternative embodiments, protective circuitry 775 may also be located in capturing unit 710, on flexible printed circuit board 765, or in power unit 720.

Protective circuitry 775 may be configured to protect image sensor 220 and/or other elements of capturing unit 710 from potentially dangerous currents and/or voltages produced by mobile power source 520. Protective circuitry 775 may include passive components such as capacitors, resistors, diodes, inductors, etc., to provide protection to elements of capturing unit 710. In some embodiments, protective circuitry 775 may also include active components, such as transistors, to provide protection to elements of capturing unit 710. For example, in some embodiments, protective circuitry 775 may comprise one or more resistors serving as fuses. Each fuse may comprise a wire or strip that melts (thereby braking a connection between circuitry of image capturing unit 710 and circuitry of power unit 720) when current flowing through the fuse exceeds a predetermined limit (e.g., 500 milliamps, 900 milliamps, 1 amp, 1.1 amps, 2 amp, 2.1 amps, 3 amps, etc.) Any or all of the previously described embodiments may incorporate protective circuitry 775.

In some embodiments, the wearable apparatus may transmit data to a computing device (e.g., a smartphone, tablet, watch, computer, etc.) over one or more networks via any known wireless standard (e.g., cellular, Wi-Fi, Bluetooth®, etc.), or via near-filed capacitive coupling, other short range wireless techniques, or via a wired connection. Similarly, the wearable apparatus may receive data from the computing device over one or more networks via any known wireless standard (e.g., cellular, Wi-Fi, Bluetooth®, etc.), or via near-filed capacitive coupling, other short range wireless techniques, or via a wired connection. The data transmitted to the wearable apparatus and/or received by the wireless apparatus may include images, portions of images, identifiers related to information appearing in analyzed images or associated with analyzed audio, or any other data representing image and/or audio data. For example, an image may be analyzed and an identifier related to an activity occurring in the image may be transmitted to the computing device (e.g., the “paired device”). In the embodiments described herein, the wearable apparatus may process images and/or audio locally (on board the wearable apparatus) and/or remotely (via a computing device). Further, in the embodiments described herein, the wearable apparatus may transmit data related to the analysis of images and/or audio to a computing device for further analysis, display, and/or transmission to another device (e.g., a paired device). Further, a paired device may execute one or more applications (apps) to process, display, and/or analyze data (e.g., identifiers, text, images, audio, etc.) received from the wearable apparatus.

Some of the disclosed embodiments may involve systems, devices, methods, and software products for determining at least one keyword. For example, at least one keyword may be determined based on data collected by apparatus 110. At least one search query may be determined based on the at least one keyword. The at least one search query may be transmitted to a search engine.

In some embodiments, at least one keyword may be determined based on at least one or more images captured by image sensor 220. In some cases, the at least one keyword may be selected from a keywords pool stored in memory. In some cases, optical character recognition (OCR) may be performed on at least one image captured by image sensor 220, and the at least one keyword may be determined based on the OCR result. In some cases, at least one image captured by image sensor 220 may be analyzed to recognize a person, an object, a location, a scene, and so forth. Further, the at least one keyword may be determined based on the recognized person, object, location, scene, etc. For example, the at least one keyword may comprise: a person's name, an object's name, a place's name, a date, a sport team's name, a movie's name, a book's name, and so forth.

In some embodiments, at least one keyword may be determined based on the user's behavior. The user's behavior may be determined based on an analysis of the one or more images captured by image sensor 220. In some embodiments, at least one keyword may be determined based on activities of a user and/or other person. The one or more images captured by image sensor 220 may be analyzed to identify the activities of the user and/or the other person who appears in one or more images captured by image sensor 220. In some embodiments, at least one keyword may be determined based on at least one or more audio segments captured by apparatus 110. In some embodiments, at least one keyword may be determined based on at least GPS information associated with the user. In some embodiments, at least one keyword may be determined based on at least the current time and/or date.

In some embodiments, at least one search query may be determined based on at least one keyword. In some cases, the at least one search query may comprise the at least one keyword. In some cases, the at least one search query may comprise the at least one keyword and additional keywords provided by the user. In some cases, the at least one search query may comprise the at least one keyword and one or more images, such as images captured by image sensor 220. In some cases, the at least one search query may comprise the at least one keyword and one or more audio segments, such as audio segments captured by apparatus 110.

In some embodiments, the at least one search query may be transmitted to a search engine. In some embodiments, search results provided by the search engine in response to the at least one search query may be provided to the user. In some embodiments, the at least one search query may be used to access a database.

For example, in one embodiment, the keywords may include a name of a type of food, such as quinoa, or a brand name of a food product; and the search will output information related to desirable quantities of consumption, facts about the nutritional profile, and so forth. In another example, in one embodiment, the keywords may include a name of a restaurant, and the search will output information related to the restaurant, such as a menu, opening hours, reviews, and so forth. The name of the restaurant may be obtained using OCR on an image of signage, using GPS information, and so forth. In another example, in one embodiment, the keywords may include a name of a person, and the search will provide information from a social network profile of the person. The name of the person may be obtained using OCR on an image of a name tag attached to the person's shirt, using face recognition algorithms, and so forth. In another example, in one embodiment, the keywords may include a name of a book, and the search will output information related to the book, such as reviews, sales statistics, information regarding the author of the book, and so forth. In another example, in one embodiment, the keywords may include a name of a movie, and the search will output information related to the movie, such as reviews, box office statistics, information regarding the cast of the movie, show times, and so forth. In another example, in one embodiment, the keywords may include a name of a sport team, and the search will output information related to the sport team, such as statistics, latest results, future schedule, information regarding the players of the sport team, and so forth. For example, the name of the sports team may be obtained using audio recognition algorithms.

### Selective Reading of Text

In some embodiments, documents or other materials including printed or written text may be captured by a capture device of apparatus 110. A user of wearable apparatus 110 may wish for some or all of the captured text to be read or otherwise presented to the user. Accordingly, the wearable apparatus may recognize the text represented in the image and may present the recognized text to the user, either audibly (e.g., through a speaker of the wearable apparatus, or through another device) or by other suitable means. However, in some instances, a user may be interested in particular portions of the text or may wish to navigate through the text in a particular manner. Accordingly, rather than reading all (or a substantial portion) of the recognized text as a single block of text, the wearable apparatus may analyze the text to determine and store one or more structural elements of the text. For example, whenever a change in font type, font size, font color, distance between lines, paragraphs or columns, or the like, is detected, a different element of the text may be identified and stored, such as a headline, a picture caption, a new paragraph, a new column, or the like.

The user may then be able to input a request to read particular portions of the text based on the identified structural elements. For example, the user may request that the device “read the appetizers,” and the device may identify an appetizer section of a menu based on the identified structural elements. In another example, the user may request that the device “read the total,” and the device may identify the total sum of a bill to be paid. This functionality may be beneficial in a variety of ways. For example, the selective reading of text may be helpful for users that are visually impaired and may have trouble reading some or all of the printed or written text. For example, a user may have difficulty reading a menu in a dimly lit restaurant or may have trouble reading documents where the font size is too small. Rather than waiting for the apparatus to read the entire menu (or document), the user could specify he or she is only interested in a particular section (e.g., the dessert section). The disclosed device may be equally useful to users without an impairment as well. For example, the system may be able to quickly identify relevant sections of a complex or convoluted document for a user. As another example, the wearable apparatus may read a relevant section of a document to a user without requiring the user to continuously look at the document. For example, the device may identify and store a relevant section of the document and read the section to the user while he or she walks away from the document or begins working on another task. Thus, the disclosed embodiments may provide, among other advantages, improved efficiency, convenience, and functionality over prior art devices.

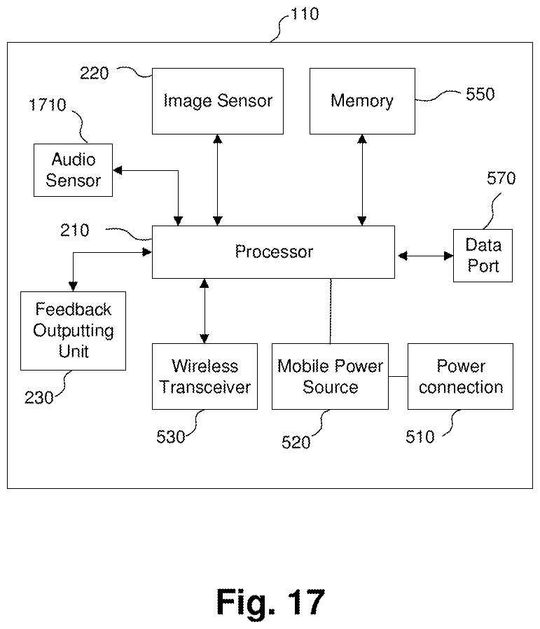

In some embodiments, apparatus 110 may be configured to receive and process audio information. For example, apparatus 110 may detect and capture sounds in the environment of the user via one or more microphones. Apparatus 110 may use this audio information to recognize words spoken by the user, which may include commands to read particular portions of text identified by a user. FIG. 17 is a block diagram illustrating components of wearable apparatus 110, consistent with the disclosed embodiments. The wearable apparatus shown in FIG. 17 may include one or more of the features shown in FIG. 5A. For example, as discussed in greater detail above, wearable apparatus 110 may include a processor 210, image sensor 220, memory 550, wireless transceiver 530 and various other components as shown in FIG. 17. Wearable apparatus 110 may further comprise an audio sensor 1710. Audio sensor 1710 may be any device capable of capturing sounds from an environment of a user and converting them to one or more audio signals. For example, audio sensor 1710 may comprise a microphone or another sensor (e.g., a pressure sensor, which may encode pressure differences comprising sound) configured to encode sound waves as a digital signal. As shown in FIG. 17, processor 210 may be configured to receive signals from audio sensor 1710 in addition to signals from image sensor 220. Further, while the system shown in FIG. 5A is used by way of example, audio sensor 1710 may be included in various other configurations of wearable apparatus 110. For example, the configurations shown in FIGS. 5B and 5C may similarly include audio sensor 1710 in communication with processor 210.

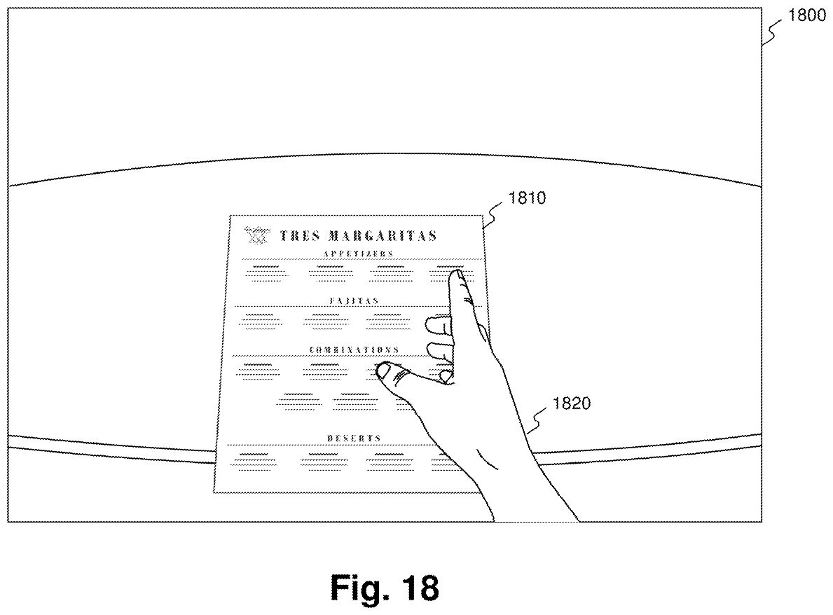

FIG. 18 is an illustration of an example image 1800 that may be read selectively, consistent with the disclosed embodiments. Image 1800 may be captured using an image sensor, such as image sensor 220 of wearable apparatus 110. Accordingly, image 1800 may include representations of text within the environment of a user of wearable apparatus 110. For example, image 1800 may include representations of documents or other objects containing text, such as menu 1810. While a menu is used by way of example in FIG. 18, wearable apparatus 110 may be configured to recognize text in any object that may include printed or written text. For example, this may include books, letters, journals, magazines, bills, invoices, notices, contracts, reports, financial documents, advertisements, cards (e.g., identification cards, credit cards, business cards, etc.), emails, checks, signs (e.g., road signs, information signs, etc.), or any other object or display that may include text. This text may be printed on a physical object or may be presented on an electronic display. Accordingly, wearable apparatus may be configured to identify these objects through various object and feature detection techniques. For example, this may include image detection or processing algorithms such as convolutional neural networks (CNN), scale-invariant feature transform (SIFT), histogram of oriented gradients (HOG) features, or other techniques. The wearable apparatus may further be configured to process text detected in the image to extract the text data and characteristics of the text. Accordingly, wearable apparatus 110 may be configured to use one or more text recognition techniques, such as optical character recognition (OCR), or similar techniques.

In some embodiments, wearable apparatus 110 may further be configured to detect objects within the environment of the user. For example, wearable apparatus 110 may be configured to detect a hand 1820 of the user. Hand 1820 (and/or other objects that may be relevant to the selective reading of text, such as a pointer, etc.) may be identified using various object and feature detection techniques, as described above. In some embodiments, hand 1820 may be used to provide requests for selectively reading text in menu 1810. For example, the user may point to particular portions of menu 1810, and wearable apparatus 110 may read structural elements within the vicinity of where the user is pointing. As another example, the user may make gestures with hand 1820 for selectively reading portions of the text. For example, the user may make a gesture associated with a particular structural element (e.g., the title), or may make a gesture to navigate the text (e.g., a gesture to move to the next paragraph, etc.). Various other example gestures or inputs that may be provided using hand 1820 are described below.

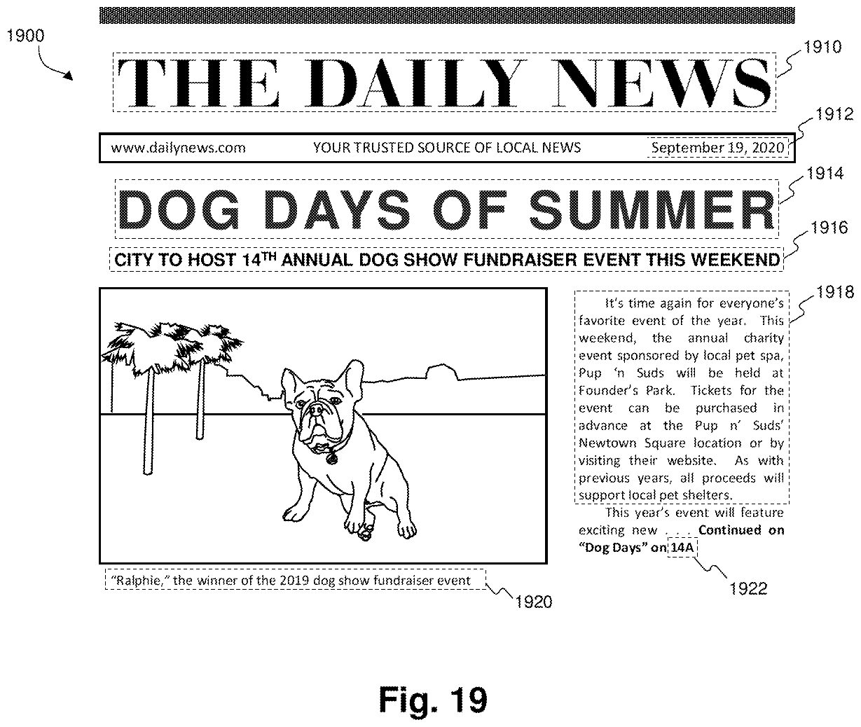

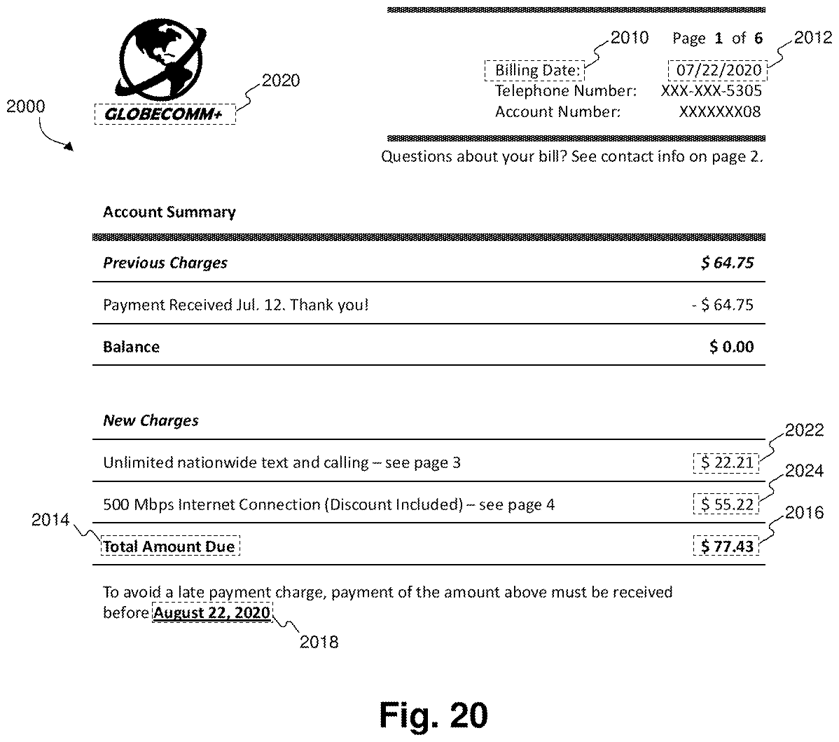

FIGS. 19 and 20 illustrate example documents that may be analyzed for selectively reading text, consistent with the disclosed embodiments. For example, the disclosed systems may be configured to analyze and selectively read text from a newspaper 1900, as shown in FIG. 19. An image sensor of wearable apparatus 110, such as image sensor 220, may capture an image (similar to image 1800) that may include a representation of newspaper 1900. The system may then process the image to detect text represented in the image. In the example shown in FIG. 18, this may include various titles, articles, and/or captions. The system may then identify one or more structural elements of identified text. As used herein, a structural element may include any text having a distinct or recognized format or configuration. Example structural elements may include titles, headings, subheadings, form fields, captions, labels, paragraphs, subparagraphs, sentences, web pages, values (e.g., dates, dollar amounts, distances, etc.), page numbers, tables of contents, lists, abstracts, summaries, tables, barcodes, or other items that may make up a structure of a document or body of text. In the example shown in FIG. 19, such structural elements may include newspaper name 1910, date 1912, article title 1914, subtitle 1916, paragraph 1918, caption 1920, and/or page number 1922.

The system may recognize these and other structural elements in various ways. In some embodiments, recognizing the structural element may include identifying one or more characteristics of the text, which may indicate separate structural elements within the text. In some embodiments, the characteristic may include a font property, such as a letter size, font or typeface, typeface variation (e.g., bold, extra bold, light, italic, condensed, extended, etc.), color, underlining, transparency, shadowing, outlining, ligatures, highlighting, strikethrough, subscripting, superscripting, capitalization, whether the text is handwritten, raised or embossed lettering or other 3-dimensional properties, or the like. As another example, the characteristic may be a paragraph or layout property, such as paragraph justification, spacing between lines, indentation, paragraph styles, margins, or the like. Various other characteristics may include spacing between elements, a location of the element on a page, arrangement of an element relative to other elements (e.g., above, below, next to, etc.), location of an element within a line of text or a paragraph, symbols or characters (e.g., stars, asterisks, arrows, brackets, quotation marks, bullets, or other symbols that may highlight a portion of text), or various other characteristics that may indicate distinct structural elements in a document or body of text. Such characteristics may be identified, for example, through various image detection techniques, through OCR techniques, or the like.

The system may be configured to store data associated with each of the identified structural elements, for example, in memory 550 described above. For example, this data may include the text included in the structural elements and a classification of the structural element (e.g., “heading,” “paragraph,” etc.). In some embodiments, the data may include an identifier associated with the structural element, which may be generated by wearable apparatus 110. For example, the data may include a structural element name (e.g., “heading1”), a unique identifier, such as a random, semi-random, consecutive, or other form of numerical identifier, or other suitable identifiers. In some embodiments, the data may include a relative location on a page. For example, this may include a general region (e.g., “top-left”), a coordinate (e.g., based on a coordinate system of an image, a coordinate system of a page, etc.), a distance or position relative to a user, or the like. In some embodiments, the stored data may reference other structural elements. For example, the system may store an indication that title 1914, subtitle 1916, paragraph 1918, caption 1920, and/or page number 1922 are associated with each other. In some embodiments, the system may recognize an overall structure associated with the elements, for example, recognizing that subtitle 1916, paragraph 1918 and caption 1920 are “nested” under title 1914. As another example, one or more menu items may be nested under an “Entrees” title or subtitle of a menu.

In some embodiments, wearable apparatus 110 may be configured to selectively read text to a user of wearable apparatus 110. This may include reading a portion of the text identified based on one or more structural elements identified in the recognized text. For example, the system may selectively read a title, heading, subtitle, date, paragraph, or other portion of text recognized in the image. The portion of text may be presented to the user in various ways. In some embodiments, the portion of text may be audibly presented to a user. Accordingly, the disclosed systems may include one or more speech synthesis algorithms (i.e. text to speech) configured to convert the recognized text to an audio signal. For example, this may include various concatenation, formant, articulatory, HMM-based, sinewave, or deep learning-based synthesis algorithms. The resulting audio signals, which may include a simulated human voice, may be presented through one or more speakers. The speaker may be included in wearable apparatus 110 (e.g., feedback outputting unit 230) or may be included on a separate device. For example, presenting the portion of text may include transmitting an audio signal (or text data) to an external device, such as a hearing interface device (e.g., a hearing aid), a mobile device (e.g., computing device 120), a vehicle audio system, a Bluetooth™ speaker, or the like.

Various other means for presenting the portion of text may also be used. In some embodiments, the text may be visually displayed to the user. For example, the text may be displayed on a user interface, such as through computing device 120. In some embodiments, the text may be displayed with different visual characteristics than those that appear in the original image. For example, the color, font size, typeface, or other properties may be altered to make them easier to read than as presented in the document or image. In some embodiments, presenting the portion of text may include transmitting or storing the portion of text. For example, presenting the text may include uploading the text to a storage location (e.g., a remote server, a cloud-based platform, a local storage device, etc.), sending the portion of text via text message (e.g., SMS), emailing the portion of text, inserting the portion of text into an existing file or document, or the like. In some embodiments, presenting the portion of text may further include processing the text or information associated with the text. For example, the text may be translated into another language before being presented to the user. In some embodiments, the system may be configured to translate other text elements to as part of processing the document. For example, when a user requests the “appetizers” to be read, the system may recognize a heading containing the text “apertivos” as a Spanish word for appetizers and may translate portions of text below the heading to present to the user.

In some embodiments, the portion of text may be selected based on an input from a user. For example, the user may provide a request to read a portion of text associated with an identified structural element. The request may be provided in various ways. In some embodiments the request may be a spoken request that may be identified through processing audio signals received through audio sensor 1710. For example, the user may say “please read the date” and the system may be configured to read date 1912 shown in FIG. 19. Similarly, the user may ask a question “What's the title of the newspaper?” and the system may read newspaper name 1910. In some embodiments, this may include identifying one or more descriptor words within the audio signal. For example, the system may recognize the words “date” or “title” and may associated those with date and title structural elements, respectively. The system may then analyze recognized structural elements to identify a match between the spoken descriptor and the determined structural element classifications, although the spoken descriptor (e.g., “date”, “title”) may not necessarily appear explicitly in the text.

According to some embodiments, the user may provide a command triggering detection of the descriptor word. For example, the user may say “read the first article,” “please read the titles,” or “what is the date.” The system may recognize “read,” “please read,” or “what is” as commands triggering detection of the descriptor word. Various other commands, such as “next paragraph” or “previous article” may be used to navigate through portions of text in the document. The system may use word spotting or other speech recognition tools to detect the commands. In some embodiments, the descriptor word may be identified based on its proximity within the audio signal to the command For example, the system may look for a descriptor word following (or in some cases, preceding) the command. In some embodiments, the command may be a predefined command or set of commands known by the user. Alternatively, or additionally, the system may be configured to recognize commands from the user's natural speech. In some embodiments, the command may be determined through natural language processing algorithms. For example, the user may use alternative words, such as “starters,” “antipasto,” or “hors d'oeuvres” when asking to read the appetizer section. Various other means for triggering detection of the descriptor word may be used. For example, the user may press a button or select an option through a graphical user interface (e.g., on computing device 120) indicating the user will provide the descriptor word.

In some embodiments, the portion of text to be read may not be the same as the structural element identified by the user. For example, if a user says “please dictate the dog article,” the system may recognize title 1914 includes the word “dog” and thus the user may wish to hear an article associated with title 1914. Accordingly, the system may begin reading paragraph 1918 (and/or subtitle 1916). As another example, if a user says “read me the appetizers,” rather than reading a subheading including the word “appetizers,” the system may recognize that food items are commonly listed below a subheading and may begin reading a menu item below this subheading. In some embodiments, the portion of text may be identified by other descriptions, such as a location on a page. For example, a user may say “read me the last paragraph on the page” or “read the third menu item under soups.” Accordingly, the system may be configured to identify structural elements based on spatial relationships with each other and/or in relation to a document or page. In some embodiments, the system may be configured to recognize non-text elements within the image and identify portions of text based on the non-text elements. For example, the user may ask the system to “read the caption for the dog picture” and, based on processing images included in newspaper 1900, the system may identify caption 1920 as a portion of text to be read to the user.

Additionally, or alternatively, the system may be configured to recognize one or more gestures by a user for selectively reading text. For example, the system may be configured to recognize a hand (e.g., hand 1820) or other objects associated with a user in one or more image frames to detect a gesture. As noted above, the system may be configured to associate one or more hand gestures with specific commands. For example, the user may make a fist (or other hand gesture) to indicate he or she would like the system to read a portion of text. Various other hand gestures or formations may be associated with particular structural elements, such as titles, subtitles, paragraphs, etc. In some embodiments the system may recognize a number of fingers being held up to indicate which paragraph, article, or other element the user is referring to (e.g., “first paragraph,” etc.). Other gestures, such as a flick of a finger, a thumbs up or down, or the like may indicate a command such as “next paragraph” or “next article.’ In some embodiments the gestures may be based on a standardized or universally recognized set of gestures, such as American sign language (ASL). Alternatively, or additionally, one or more commands may be preprogrammed into the device, or manually set by the user. For example, the system may include a set of predetermined gestures that the user may associate with particular commands, for example, through a user interface on computing device 120. In some embodiments, the user may teach the system gestures through a learning phase, in which the user indicates a command and makes a training gesture within the view of the camera, which the system will then associate with a particular command. While hand gestures are used by way of example, various other gestures may be recognized For example, if wearable apparatus 110 is formed as a pair of glasses, the user may nod or shake his or her head to indicate a command. The system may use relative movements between image frames, accelerometer data, or other sensor information to detect the gestures.

In some embodiments, the system may be configured to present structural elements to the user according to a predetermined order or hierarchy. For example, the system may know to read titles, then associated subtitles, and then associated paragraphs, rather than reading elements from left to right or in other orders that may not be as intuitive to a user. As another example, the system may first read all article titles within newspaper 1900 and then may await a command from a user to read any of the identified articles. As yet another example, a user may prefer to read only image captions, or only the dessert items on a menu by default. Accordingly, these predetermined orders or hierarchies may be set by the user, for example, through a voice command, through a user interface (e.g., on computing device 120), or the like. In some embodiments, the system may be configured to skip various structural elements, such as advertisements, dates, titles that repeat on each page, author names, citations, or other elements a user may not be interested in.

According to some embodiments, the system may be configured to extract information from the text. For example, the system may use one or more natural language processing algorithms to extract information from within the structural elements. Using the example shown in FIG. 19, the user may say “when is the dog show?” and, based on the text of subtitle 1916, the system may determine the event will be held during the upcoming weekend. In some embodiments, the system may be configured to provide a command to the user based on the detected structural elements. For example, when reading newspaper 1900 the system may be configured to recognize that an article continues on page 14A as indicated by page number 1922. Accordingly, the system may issue a command to “turn to page 14A” after reading paragraph 1918. Various other forms of information analysis and/or commands may be presented to the user.

As another illustrative example, the disclosed system may perform selective reading techniques on a document, such as phone bill 2000 shown in FIG. 20. Phone bill 2000 may include various information relating to a user's mobile phone and internet bill. In particular, phone bill 2000 may include various fields with associated labels. For example, date field 2012 may be associated with a billing date label 2010. Similarly, phone bill 2000 may include a total amount field 2016 and an associated total amount due label 2014. The system may be configured to recognize these fields and labels as structural elements and may associate the fields with the corresponding labels. For example, date field 2012 may be associated with billing date label 2010 based on the two being placed along a line at the same vertical height within the page of phone bill 2020. The colon within billing date label 2010, or similar characters, may also indicate a structural element is a label Similarly, because amount 2016 and total amount due label 2014 are within the same two horizontal lines, they may be associated with each other. Accordingly, a user may ask “what is the date of this bill” or “what is the amount of this bill” and the system may read fields 2012 and 2016, respectively.

In some embodiments, the system may identify a label based on natural language processing or other text analysis. For example, based on the bold and underlined font, the system may recognize due date field 2108 as a field. The system may then analyze the surrounding text to determine this field represents a due date. Accordingly, a user may ask “when is this bill due?” and the system may read due date field 2018. As another example, due to the position, font, and proximity to a logo, the system may recognize a company name 2020 as the company issuing the phone bill. In some embodiments, the system may be configured to store a position or other characteristics of fields identified in documents to use in recognizing fields in subsequent documents. For example, the system may store locations of fields in previous Globecomm+ phone bills, which may indicate information included in the same location in subsequent Globecomm+ phone bills correspond to the same type of field.

In some embodiments, the system may further be configured to analyze one or more values included in phone bill 2000. For example, the user may ask “what is the total of new charges?” and the system may determine a sum of values 2022 and 2024. The system may further compare this value to the value in field 2016 and warn the user of any discrepancies. As another example, the user may ask “did my bill go up?” and the system may read a stored value for field 2016 along with an associated date from field 2012 from a previous Globecomm+ phone bill that may be stored in memory.

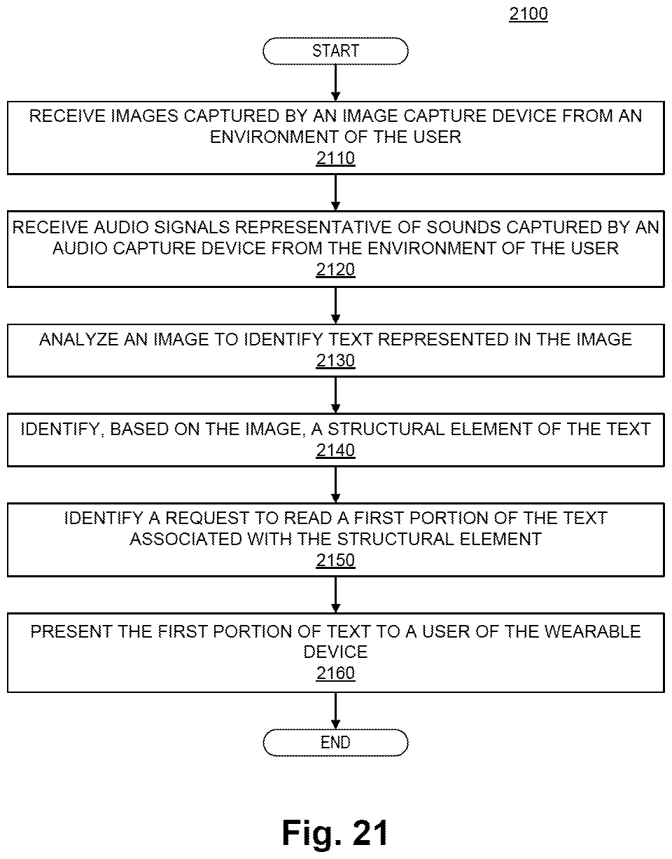

FIG. 21 is a flowchart showing an example process 2100 for selectively reading text, consistent with the disclosed embodiments. Process 2100 may be performed by at least one processing device of a wearable apparatus, such as processor 210, as described above. In some embodiments, some or all of process 2100 may be performed by a different device, such as computing device 120. It is to be understood that throughout the present disclosure, the term “processor” is used as a shorthand for “at least one processor.” In other words, a processor may include one or more structures that perform logic operations whether such structures are collocated, connected, or disbursed. In some embodiments, a non-transitory computer readable medium may contain instructions that when executed by a processor cause the processor to perform process 2100. Further, process 2100 is not necessarily limited to the steps shown in FIG. 21, and any steps or processes of the various embodiments described throughout the present disclosure may also be included in process 2100, including those described above with respect to FIGS. 18-20.

In step 2110, process 2100 may include receiving a plurality of images captured by an image capture device from an environment of the user. For example, this may include receiving image 1800 captured by image sensor 220. As described above, one or more of the images may include representations of text within the environment of the user.

In step 2120, process 2100 may include receiving audio signals representative of sounds captured by an audio capture device from the environment of the user. For example, audio sensor 1710 may capture sounds from the environment of the user and may transmit them to processor 210. This may include voice commands spoken by the user, as described above.

In step 2130, process 2100 may include analyzing at least one image of the plurality of images to identify text represented in the image. For example, step 2130 may include identifying text within menu 1810, newspaper 1900, or phone bill 2000. Step 2130 may include accessing and/or applying one or more image recognition algorithms, OCR techniques, natural language processing algorithms, or the like, as described above.

In step 2140, process 2100 may include identifying, based on the image, a structural element of the text. As described above, the structural element may include at least one of a heading, a subheading, a caption of a picture, a paragraph, a subparagraph, a field or a list item. In some embodiments, the structural element may comprise a field. A label of the field may appear in a vicinity of the field, as described above with respect to FIG. 20. In some embodiments, the structural element may be determined based on one or more characteristics of the text. Accordingly, step 2140 may further include determining a characteristic of the text and the structural element may be identified based on the characteristic. The characteristic may include, for example, at least one of a font, a letter size, a style, or a location within a page. Additional example characteristics are described in greater detail above.

In step 2150, process 2100 may include identifying a request to read a first portion of the text associated with the structural element. The request may be presented by the user in various forms. For example, the request may be identified by at least one of analyzing the audio signals to detect a spoken request or detecting a gesture in the plurality of images. In embodiments where spoken requests are presented, step 2150 may include analyzing the audio signals to detect a command. For example, the command may be a user-defined command, a default command, a command recognized through natural language processing, or the like. In some embodiments, the request may be identified based on the detected command For example, step 2150 may include determining a descriptor word based on a proximity of the detector word to the command within the audio signal. For example, the request may comprise a word to be detected within the structural element of the text. In some embodiments, the descriptor word itself may not necessarily appear in the text. For example, the request may comprise a word indicating the structural element of the text but not appearing in the text. In embodiments where gestures are used, the detected gesture may comprise a predetermined gesture associated with the structural element. The predetermined gesture may be a default gesture, a user-defined gesture, a gesture the system is trained to recognize by the user, or the like as described above.

In step 2160, process 2100 may include presenting the first portion of text to the user of the wearable device. As described above, the first portion of text may be presented in various ways. In some embodiments, presenting the first portion of text to the user may comprise audibly presenting a representation of the first portion of the text. For example, presenting the first portion of text to the user may comprise presenting a representation of the first portion of text via a speaker. As another example, presenting the first portion of text to the user may comprise transmitting a representation of the first portion of text to a hearing aid interface associated with the user. In some embodiments, process 2100 may include presenting multiple portions of text to a user. For example, process 2100 may include analyzing the audio signals to identify a request to read a second portion of the text associated with a second structural element identified based on the image and presenting the second portion of the text to the user. In some embodiments, identifying the structural element comprises identifying a plurality of structural elements, and process 2100 may further include presenting the text to the user according to a predetermined order of the structural elements. The predetermined order may be defined as a default parameter, defined by the user, or may be defined by other means.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, Ultra HD Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A wearable apparatus for capturing and processing images, the wearable apparatus comprising:
at least one image sensor configured to capture a plurality of images from an environment of a user of the wearable apparatus;
at least one audio capture device configured to receive sounds from the environment of the user; and
at least one processor programmed to:
receive an image captured by the image sensor;
receive audio signals representative of the sounds captured by the audio capture device;
analyze the image to identify text represented in the image;
identify, based on the image, a structural element of the text;
identify a request to read a first portion of the text associated with the structural element, the request being identified by at least one of analyzing the audio signals to detect a spoken request or detecting a gesture in the plurality of images; and
present the first portion of text to the user of the wearable apparatus.

2. The wearable apparatus of claim 1, wherein presenting the first portion of text to the user comprises audibly presenting a representation of the first portion of the text.

3. The wearable apparatus of claim 1, wherein the wearable apparatus further comprises a speaker and wherein the first portion of text is presented via a speaker.

4. The wearable apparatus of claim 1, wherein presenting the first portion of text to the user comprises transmitting a representation of the first portion of text to a hearing aid interface associated with the user.

5. The wearable apparatus of claim 1, wherein the at least one processor is further programmed to analyze the audio signals to detect a command.

6. The wearable apparatus of claim 5, wherein the request is identified based on the detected command.

7. The wearable apparatus of claim 1, wherein the request comprises a word indicating the structural element of the text but not appearing in the text.

8. The wearable apparatus of claim 1, wherein the request comprises a word to be detected within the structural element of the text.

9. The wearable apparatus of claim 1, wherein the detected gesture comprises a predetermined gesture associated with the structural element.

10. The wearable apparatus of claim 1, wherein the at least one processor is further programmed to:
analyze the audio signals to identify a request to read a second portion of the text associated with a second structural element identified based on the image; and
present the second portion of the text to the user.

11. The wearable apparatus of claim 1, wherein the at least one processor is further programmed to determine a characteristic of the text, the characteristic comprising at least one of a font, a letter size, a style, or a location within a page.

12. The wearable apparatus of claim 1, wherein the structural element comprises at least one of a heading, a subheading, a caption of a picture, a paragraph, a subparagraph, or a list item.

13. The wearable apparatus of claim 1, wherein the structural element comprises a field, and wherein a label of the field appears in a vicinity of the field.

14. The wearable apparatus of claim 1, wherein identifying the structural element comprises identifying a plurality of structural elements, and wherein the at least one processor is further configured to present the text to the user according to a predetermined order of the structural elements.

15. A method for selectively reading text, the method comprising:
receiving a plurality of images captured by an image capture device from an environment of a user;
receiving audio signals representative of sounds captured by an audio capture device from the environment of the user;
analyzing at least one image of the plurality of images to identify text represented in the image;
identifying, based on the image, a structural element of the text;
identifying a request to read a first portion of the text associated with the structural element, the request being identified by at least one of analyzing the audio signals to detect a spoken request or detecting a gesture in the plurality of images; and
presenting the first portion of text to a wearable device of the user.

16. The method of claim 15, wherein presenting the first portion of text to the user comprises audibly presenting a representation of the first portion of the text.

17. The method of claim 15, wherein presenting the first portion of text to the user comprises presenting a representation of the first portion of text via a speaker.

18. The method of claim 15, wherein presenting the first portion of text to the user comprises transmitting a representation of the first portion of text to a hearing aid interface associated with the user.

19. The method of claim 15, wherein the method further comprises analyzing the audio signals to detect a command.

20. The method of claim 19, wherein the request is identified based on the detected command.

21. The method of claim 15, wherein the request comprises a word indicating the structural element of the text but not appearing in the text.

22. The method of claim 15, wherein the request comprises a word to be detected within the structural element of the text.

23. The method of claim 13, wherein the detected gesture comprises a predetermined gesture associated with the structural element.

24. The method of claim 13, wherein the method further comprises:
analyzing the audio signals to identify a request to read a second portion of the text associated with a second structural element identified based on the image; and
presenting the second portion of the text to the user.

25. The method of claim 13, wherein the method further comprises determining a characteristic of the text, the characteristic comprising at least one of a font, a letter size, a style, or a location within a page.

26. The method of claim 13, wherein the structural element comprises at least one of a heading, a subheading, a caption of a picture, a paragraph, a subparagraph, a field or a list item.

27. The method of claim 13, wherein identifying the structural element comprises identifying a plurality of structural elements, and the method further comprises presenting the text to the user according to a predetermined order of the structural elements.
